(19) United States
(12) Patent Application Publication
(10) Pub. No.: US 2026/0092656 A1
(43) Pub. Date: Apr. 2, 2026

(54) GIMBALLED CANTILEVERED ACTUATING BEAM FOR MICRO-VALVE SEALING

(71) Applicant: MATTHEWS INTERNATIONAL CORPORATION, Pittsburgh, PA (US)

(72) Inventors: William BUSKIRK, Albany, OR (US); Jeff HESS, Corvallis, OR (US); Douglas DEAN, Corvallis, OR (US); Kenneth TRUEBA, Corvallis, OR (US); Charles C. HALUZAK, Philomath, OR (US); Alex TULCHINSKY, Corvallis, OR (US); Daniel HEIDEMEYER, Albany, OR (US); Eric MILLER, Seattle, WA (US)

(21) Appl. No.: 19/343,509

(22) Filed: Sep. 29, 2025

Related U.S. Application Data
(60) Provisional application No. 63/701,132, filed on Sep. 30, 2024.

(51) Int. Cl. F16K 99/00

(52) U.S. Cl. CPC F16K 99/0048; F16K 99/0007

(57) ABSTRACT

A gimballed cantilevered actuating beam for sealing micro-valves is disclosed. The micro-valve includes an orifice plate and an orifice extending through the orifice plate. An actuating beam is disposed in spaced relation to the orifice plate. The actuating beam comprises a base portion separated from the orifice plate by a predetermined distance and a cantilevered portion extending from the base portion towards the orifice. An overlapping portion of the actuating beam overlaps the orifice and is flexibly affixed to the remainder of the cantilevered portion by at least one rib, allowing the overlapping portion to gimbal. A sealing structure is disposed at the overlapping portion, which seals the orifice when the actuating beam is in the closed position.

### CROSS REFERENCE TO RELATED APPLICATIONS

This application claims the benefit of U.S. Provisional Ser. No. 63/701,132 filed Sep. 30, 2024 which is incorporated herein by reference.

### TECHNICAL FIELD

The present disclosure relates generally to the field of micro-valves fabricated using micro-electro-mechanical systems (MEMS) techniques.

### BACKGROUND

Micro-valves are a type of valve that are typically used in microfluidic systems. These systems are often used in applications that require precise control of small volumes of fluids, such as in the fields of biotechnology, medical diagnostics, and inkjet printing. Micro-valves are typically designed to control the flow of fluid through an orifice, which is a small opening or hole in a plate or a wall.

There are several challenges associated with piezoelectric micro-valves. One of the main challenges is the efficient sealing of the orifice when the micro-valve is in the closed position. The operation of piezoelectric actuators introduces a bend into the actuating beam. This bend may lead to misalignment or uneven/insufficient sealing of the actuating beam against an orifice. Misalignment or uneven/insufficient sealing may lead to fluid dripping in an undesired direction (e.g., away from an intended target). Furthermore, fluid may be lost over time as a result of evaporation, requiring continuous replenishment.

Therefore, there is a demand for improved micro-valve designs that can overcome these and other challenges. In particular, there is a demand for micro-valve designs that provide more efficient and reliable sealing of the orifice and that allow for better control of the actuating beam's movement.

### SUMMARY

A micro-valve may include an orifice plate including a first surface and a second surface, the orifice plate comprising an orifice extending from the first surface to the second surface and an actuating beam disposed in spaced relation to the orifice plate. The actuating beam may include a base portion separated from the orifice plate by a predetermined distance, a cantilevered portion extending from the base portion towards the orifice such that an overlapping portion thereof overlaps the orifice, wherein the actuating beam is movable between a closed position and an open position, and at least one rib flexibly affixing the overlapping portion to a remainder of the cantilevered portion, wherein the overlapping portion is configured to gimbal with respect to the remainder of the cantilevered portion. The micro-valve may include a sealing structure disposed at the overlapping portion, wherein, when the actuating beam is in the closed position, the cantilevered portion is positioned such that the sealing structure seals the orifice so as to close the micro-valve.

In some embodiments, the actuating beam includes a layer of a piezoelectric material, wherein the actuating beam is movable between the closed position and the open position in response to an electrical signal being applied to the piezoelectric material.

In some embodiments, the sealing structure includes a valve seat surrounding the orifice, wherein the valve seat is affixed to the orifice plate to define a fluid outlet.

In some embodiments, the micro-valve includes a compliance layer covering at least one of an upper surface of the valve seat that faces the sealing structure or a sealing structure surface facing the valve seat.

In some embodiments, the compliance layer is etched with one or more features to reduce the surface area of the compliance layer.

In some embodiments, the sealing structure includes a first sealing blade extending a distance from an exposed surface of the sealing structure towards the orifice plate, wherein the first sealing blade surrounds an entire perimeter of the orifice.

In some embodiments, the sealing structure comprises a plurality of flat region features disposed on the overlapping portion, the flat region features configured to enhance sealing performance by increasing an effective flat region of a valve interface.

In some embodiments, the sealing structure comprises a first sealing blade extending a distance from an exposed surface of the valve seat towards the sealing structure, wherein the first sealing blade surrounds an entire perimeter of the orifice.

In some embodiments, the sealing structure further includes a second sealing blade surrounding the first sealing blade, the second sealing blade having a second outer diameter that is greater than the first outer diameter but less than the second diameter such that an annular gap is formed between the first sealing blade and the second sealing blade.

In some embodiments, the at least one rib is affixed to the overlapping portion at a single attachment location.

In some embodiments, the single attachment location is along a central axis of the actuating beam.

In some embodiments, the at least one rib is affixed to the overlapping portion at two attachment locations.

In some embodiments, the two attachment locations are symmetrically located along a central axis of the actuating beam.

In some embodiments, the two attachment locations are asymmetrically located along a central axis of the actuating beam such that the at least one rib generates an asymmetric peeling force when transitioning the actuating beam from the closed position to the open position.

In some embodiments, gimballing between the overlapping portion and the remainder of the cantilevered portion is produced predominantly through flexure of the at least one rib.

In some embodiments, gimballing between the overlapping portion and the remainder of the cantilevered portion is produced predominantly through torsion of the at least one rib.

In some embodiments, the sealing structure is predominantly cylindrical.

In some embodiments, the actuating beam is predominantly trapezoidal along the length of the actuating beam.

A valve assembly may include a valve body comprising an orifice plate including a plurality of orifices extending therethrough and a plurality of micro-valves. The plurality of micro-valves may each include an actuating beam disposed in spaced relation to the orifice plate, the actuating beam including a base portion separated from the orifice plate by a predetermined distance, a cantilevered portion extending from the base portion towards the orifice such that an overlapping portion thereof overlaps the orifice, wherein the actuating beam is movable between a closed position and an open position, and at least one rib flexibly affixing the overlapping portion to a remainder of the cantilevered portion, wherein the overlapping portion is configured to gimbal with respect to the remainder of the cantilevered portion, and a sealing structure disposed at the overlapping portion, wherein, when the actuating beam is in the closed position, the cantilevered portion is positioned such that the sealing structure seals the orifice so as to close the micro-valve. The plurality of micro-valves may each include a fluid manifold coupled to each of the plurality of micro-valves to define a fluid reservoir for each of the plurality of micro-valves.

In some embodiments, the at least one rib includes two ribs affixing the overlapping portion to the remainder of the cantilevered portion at two points.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. Various aspects of at least one example are discussed below with reference to the accompanying drawings, which are not intended to be drawn to scale. In the drawings:

FIG. 1A depicts across-sectional view of an illustrative valve assembly including a micro-valve, according to an embodiment.

FIG. 1B depicts across-sectional view of an illustrative valve assembly including a micro-valve, according to another embodiment.

FIG. 2 depicts a cross-sectional view providing a more detailed view of the valve assembly shown in FIG. 1A.

FIGS. 3-10 depict cross-sectional views of illustrative sealing structures of micro-valves, according to various embodiments.

FIG. 11 depicts a cross-sectional view of an illustrative sealing member of a micro-valve, according to an embodiment.

FIG. 12 depicts a cross-sectional view of an illustrative valve seat of a micro-valve, according to an embodiment.

FIG. 13A depicts a cross-sectional view of an illustrative sealing structure of a micro-valve, according to an embodiment.

FIG. 13B depicts a cross-sectional view of an illustrative sealing structure of a micro-valve, according to another embodiment.

FIG. 14A depicts a downward view of an illustrative asymmetrically gimballed cantilevered actuating beam, according to an embodiment.

FIG. 14B illustrates an isometric view of the asymmetrically gimballed cantilevered actuating beam of FIG. 14A, according to an embodiment.

FIG. 14C shows a side view of the asymmetrically gimballed cantilevered actuating beam of FIG. 14A, according to an embodiment.

FIG. 15A depicts a downward view of an illustrative symmetrically gimballed cantilevered actuating beam, according to an embodiment.

FIG. 15B illustrates an isometric view of the symmetrically gimballed cantilevered actuating beam of FIG. 15A, according to an embodiment.

FIG. 15C shows a side view of the symmetrically gimballed cantilevered actuating beam of FIG. 15A, according to an embodiment.

FIG. 16A depicts a downward view of an illustrative torsion gimballed cantilevered actuating beam, according to an embodiment.

FIG. 16B illustrates an isometric view of the torsion gimballed cantilevered actuating beam of FIG. 16A, according to an embodiment.

FIG. 16C shows a side view of the torsion gimballed cantilevered actuating beam of FIG. 16A, according to an embodiment.

FIG. 16D depicts a downward view of an illustrative symmetrically gimballed trapezoidal cantilevered actuating beam, according to an embodiment.

FIG. 16E illustrates an isometric view of the symmetrically gimballed trapezoidal cantilevered actuating beam of FIG. 16D, according to an embodiment.

FIG. 16F shows a side view of the symmetrically gimballed trapezoidal cantilevered actuating beam of FIG. 16D, according to an embodiment.

FIG. 17 depicts a side view of an illustrative micro-valve assembly, according to an embodiment.

FIG. 18 illustrates a change in the axis of the cantilevered portion and the axis of the sealing member as a result of gimballing in accordance with an embodiment.

FIGS. 19A and 19B illustrate example etching features for reducing stiction in accordance with one or more embodiments.

FIG. 20 illustrates a leak barrier based on the contact of the etched surface with a sealing blade in accordance with an embodiment.

FIGS. 21 and 22 illustrate redundant leak barriers in accordance with one or more embodiments.

FIG. 23 illustrates a sealing member configuration with a plurality of flat region features in accordance with an embodiment.

### DETAILED DESCRIPTION

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Those having skill in the art can also translate from the plural form to the singular as is appropriate to the context and/or application. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices also can “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

As used herein, the term “fluid” broadly refers to any substance that can flow and does not maintain a fixed shape. Fluids can be categorized into liquids, gases, plasmas, and, in some cases, solids that exhibit fluidic properties under specific conditions, such as granular materials or some biological tissues. Fluids can include, but are not limited to, water, oils, chemicals, air, steam, emulsions, suspensions, colloids, and biological fluids. They can also encompass complex mixtures with various components, such as inks, paints, adhesives, and medical or industrial formulations. The behavior and characteristics of fluids are governed by parameters such as viscosity, density, temperature, and pressure.

Referring generally to the figures, described herein is a valve assembly including multiple micro-valves. The micro-valves described herein employ an actuating beam having a sealing member disposed thereon. The utilization of such an actuating beam enables tailoring the micro-valve to eliminate or reduce various deficiencies associated with conventional technologies including continuous inkjet jetting assemblies. For example, in various embodiments, the micro-valve includes a spacing member disposed between the actuating beam and an orifice plate. The spacing member maintains a spacing of a first end of the actuating beam and an orifice within the orifice plate so as to prevent squeeze film damping of the actuating beam. The actuating beam extends over the orifice from the spacing member and a sealing member extends towards the orifice to form a seal at the orifice. Thus, without applying any electrical energy to the actuating beam, the sealing member seals off the orifice. In other words, the default position of the actuating beam (e.g., configured by careful selection of the materials contained therein) is that the micro-valve is closed. As such, fluid disposed in the micro-valve is sealed off from the external environment of the valve assembly. This eliminates evaporation of the fluid, which reduces clogs. Additionally, the limited evaporation enables faster-drying fluid to be used, which allows for printing at higher speeds than conventional systems.

To mitigate against fluid leaks, the micro-valves described herein include a sealing structure configured to form a seal that separates the orifice from a volume proximate to the actuating beam when the actuating beam is in its default position. The sealing structure may include any combination of a plurality of components designed to ensure the formation of the seal. For example, in various embodiments, the sealing structure includes a valve seat disposed on the orifice plate proximate to the orifice. The valve seat may surround the orifice and define an opening aligned with the orifice to define a fluid plenum. The sealing member may contact the valve seat with the actuating beam in the default position. In certain embodiments, the sealing structure is configured to gimbal such that a bottom surface of the sealing member is parallel to a top surface of the valve seat. In some embodiments, the valve seat is constructed of a compliant material to facilitate the formation of an enhanced seal resulting from pressure applied due to curvature of the actuating beam. In some embodiments, the pressure of the fluid may enhance the seal by exerting force against the actuating beam into the valve seat.

In another aspect, the sealing structure may include components attached to or extending from the sealing member. For example, in one embodiment, the sealing structure includes a compliant structure extending from an orifice-facing surface of the sealing member. The compliant structure may include a narrow portion and a wider portion having a cross-sectional area greater than that of the orifice. As a result, the actuating beam compresses the compliant structure towards the orifice plate to facilitate the formation of the seal. Alternatively, or additionally, the sealing structure may include a sealing blade extending from the orifice-facing surface to contact the valve seat or orifice plate. The sealing blade further facilitates the formation of the seal due to the pressure resulting from its relatively small cross-sectional area, which focuses downward pressure applied via the actuating beam to a ring surrounding the orifice to form a tight seal. Thus, the various structures described herein enhance the seals formed when the actuating beam is in its default position.

As described herein, the term “default position,” when used in describing an actuating beam of a micro-valve, describes the position of the actuating beam with respect to various other components of the micro-valve without application of any control signals (e.g., an electrical charge, current or voltage) to the actuating beam. In other words, the default position is the position of the actuating beam (and any components attached thereto) when the actuating beam is in a passive state. In certain embodiments, the actuating beam includes a mechanical bias configured to bend the beam (e.g., such that the sealing member is in contact with the valve seat) in the default position. It should be appreciated that other embodiments are envisioned in which the default position is an open position of the actuating beam.

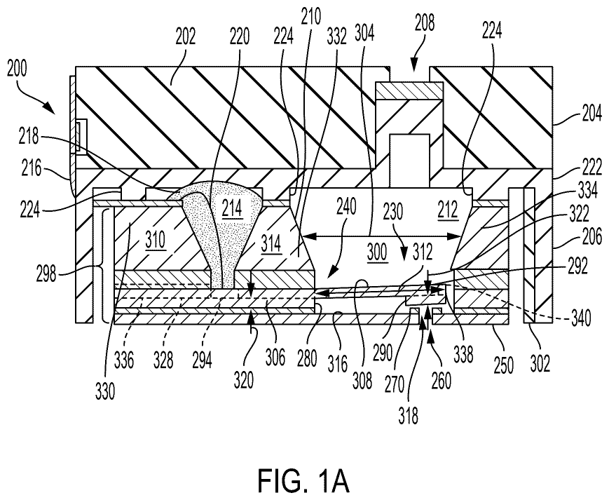

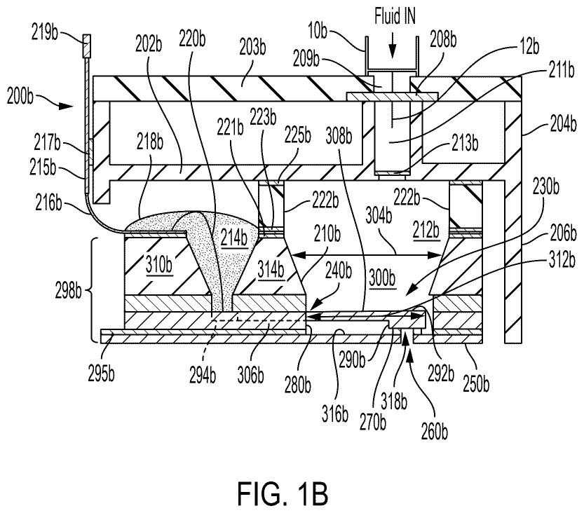

Referring now to FIG. 1A, a cross-sectional view of an illustrative valve assembly 200 including a micro-valve 230 is shown, according to an embodiment. As shown, valve assembly 200 may include a carrier 202 attached to a valve body 298 via a structural layer 222. In some embodiments, the carrier 202 may include the structural layer 222.

The carrier 202 may include an upper portion 204 and a housing portion 206 extending from an edge of upper portion 204. The upper portion 204 may include a septum 208 by which pressurized fluid is provided. In certain embodiments, the housing portion 206 defines a cavity into which the valve body 298 is disposed. The valve body 298 may include an input fluid manifold 210 and the micro-valve 230. As shown, the input fluid manifold 210 and the micro-valve 230 may define a reservoir 300 configured to hold a volume of pressurized fluid received from an external fluid supply via the septum 208. In various embodiments, the pressurized fluid held within the reservoir 300 is a combination of an ink and/or additional fluids.

The carrier 202 may be formed of plastic, ceramic, or any other suitable material. In some embodiments, the carrier 202 facilitates operation of the valve assembly 200 by providing structural support to the valve body 298. For example, in some embodiments, peripheral edges of the valve body 298 are attached to the housing portion 206 (e.g., via layers of adhesive 302 disposed at the inner surface of the housing portion 206). Adhesive may facilitate maintenance of a desired relative positioning between the micro-valve 230 and the input fluid manifold 210.

The input fluid manifold 210 may be formed by a body 310 (e.g., formed from glass, silicon, silica, etc.) having any suitable thickness (e.g., 500 microns). As shown, the input fluid manifold 210 may be pre-formed to include a first arm 330, a second arm 332, and a third arm 334. As used herein, the term “arm,” when used to describe the input fluid manifold 210, refers to a structure separating openings contained in the input fluid manifold 210. As such, the arms 330, 332, and 334 may have any suitable shape. For example, in some embodiments, the arms 330, 332, and 334 are substantially rectangular-shaped, having substantially planar side surfaces. In other embodiments, the side surfaces may be angled such that the arms 330, 332, and 334 are substantially trapezoidal-shaped. The arms 330, 332, and 334 may be formed by creating openings in a structure (e.g., a silicon or glass structure) using any suitable method (e.g., wet etching or dry etching such as deep reactive ion etching).

As shown, a first channel 212 may separate the arms 332 and 334 from one another and a second channel 214 may separate the arms 330 and 332 from one another. The first and second channels 212 and 214 may be substantially linear and parallel to one another as illustrated, but the input fluid manifold 210 may be arranged as needed for the arrangement of micro-valves to be disposed thereon. The first channel 212 may be formed to have a width 304 bearing a predetermined relationship to a length 312 of a cantilevered portion 308 of an actuating beam 240 of the micro-valve 230, for example, in a range of about 500-1,000 microns. For example, the first channel 212 may be formed to have a width 304 greater than a desired length 312 of the cantilevered portion 308 by a threshold amount. The second channel 214 may provide an avenue for an electrical connection to be formed between the actuating beam 240 and a flex circuit 216 via wire bonds 220 extending in between. Beneficially, using such an arrangement internalizes electrical connections between the actuating beam 240 and the flex circuit 216. In other words, electrical connections between such components are not external to carrier 202 and may thus be less vulnerable to degradation. In various embodiments, the first channel 212 and/or the second channel 214 may have inclined sidewalls.

Although the examples illustrated herein refer to a flex circuit 216, any manner of control circuit may be utilized. In some embodiments, a plurality of distinct micro-valves 230 may be interfaced to a single control circuit.

As shown, the second channel 214 may be substantially filled with an encapsulant 218. The encapsulant 218 may include an epoxy-type material or any other suitable material. The encapsulant 218 may envelope electrical connections formed between wire bonds 220, the flex circuit 216, and the actuating beam 240 and may be configured to protect the wire bonds 220 from physical damage, moisture and corrosion. Thus, the encapsulant 218 may ensure the maintenance of an adequate electrical connection between the flex circuit 216 and the actuating beams 240 to facilitate providing electrical control signals to the actuating beams 240 to cause movement thereof to open and close the micro-valve 230.

The input fluid manifold 210 may serve as both part of the reservoir 300 for pressured fluid received from an external fluid supply and an insulating barrier between the pressured fluid and any electrical connections contained within the valve assembly 200. The first and second channels 212 and 214 may be formed using any suitable process (e.g., via sandblasting, physical or chemical etching, drilling). In some embodiments, rather than being constructed of glass, the input fluid manifold 210 is constructed of silicon, silica, ceramics or any other suitable material. In some embodiments, the input fluid manifold 210 is bonded to the micro-valve 230 via glass frit, solder or any other suitable adhesive.

With continued reference to FIG. 1A, the micro-valve 230 includes an orifice plate 250 attached to the actuating beam 240. The orifice plate 250 may be formed from any suitable material, for example, silicon, glass, stainless steel, nickel, nickel with another layer of electroplated metal (e.g., stainless steel), polyimide (e.g., kapton) or a negative photoresist (e.g., SU-8, polymethylmethacrylate, etc.). In some embodiments, the orifice plate 250 may be substantially flat. Furthermore, the orifice plate 250 may have any suitable thickness. In some embodiments, the orifice plate 250 may have a thickness in a range of 30 microns to 100 microns. For example, the orifice plate may have a thickness of 30 microns, 35 microns, 40 microns, 45 microns, 50 microns, 55 microns, 60 microns, 70 microns, 80 microns, 90 microns, 100 microns, or a value in a range between any two of these values (including endpoints). In other embodiments, the orifice plate 250 may have a thickness in a range of 100 microns to 400 microns. For example, the orifice plate may have a thickness of 100 microns, 125 microns, 150 microns, 175 microns, 200 microns, 225 microns, 250 microns, 275 microns, 300 microns, 325 microns, 350 microns, 375 microns, 400 microns or a value in a range between any two of these values (including endpoints). Higher thickness values may also be acceptable depending on the fluid viscosity. Thicker orifice plates 250 may facilitate realization of a flatter orifice plate.

The orifice plate 250 may be substantially planar and may include an orifice 260 extending between surfaces thereof. In various embodiments, the orifice 260 is substantially cylindrical and has a central axis that is perpendicular or substantially perpendicular to surfaces of the orifice plate 250. A valve seat 270 may be disposed on an internal surface 316 of the orifice plate 250 proximate to the orifice 260. In various embodiments, the valve seat 270 comprises a compliant material that surrounds or substantially surrounds the orifice 260. In some embodiments, the valve seat 270 is constructed from an epoxy-based adhesive such as an SU-8 photoresist. In other embodiments, the valve seat 270 may be formed from a moldable polymer, such as polydimethylsiloxane or silicone rubber. In still other embodiments, the valve seat 270 may be formed from a non-compliant material such as silicon. In some embodiments, a compliant layer, such as a gold layer, may be disposed on a surface of the valve seat 270 that is contacted by the actuating beam 240. The valve seat 270 may define an interior opening 318 that is substantially aligned with the orifice 260 to create an outlet for pressured fluid contained in the reservoir 300. In particular embodiments, the valve seat 270 may be excluded.

As shown, the actuating beam 240 may include a base portion 306 and a cantilevered portion 308. The base portion 306 may extend underneath the portion 314 of the input fluid manifold 210 separating the first and second channels 212 and 214. As shown, the base portion 306 may include an electrical connection portion 294 in a region that overlaps with the second channel 214. The electrical connection portion 294 may include an electrode through which an electrical connection is formed with the flex circuit 216 via wire bonds 220. The cantilevered portion 308 may extend into the reservoir 300 from the portion 314 of the input fluid manifold 210. As shown, the cantilevered portion 308 may be disposed on a spacing member 280 and, as a result, may be spatially separated from the orifice plate 250. Thus, there may be space on either side of the cantilevered portion 308 such that the actuating beam 240 may bend towards and/or away from the orifice plate 250 as a result of application of electrical signals thereto via the electrical connection portion 294. The spacing member 280 may be configured to prevent squeeze film damping of the actuating beam.

The cantilevered portion 308 may have a length 312 such that the cantilevered portion extends from a boundary of the reservoir 300 by a predetermined distance. In various embodiments, the predetermined distance is specifically selected such that a portion 292 of the cantilevered portion 308 overlaps the valve seat 270 and the orifice 260. A sealing member 290 may extend from the portion 292 of the actuating beam 240 overlapping the orifice 260. In some embodiments, the sealing member 290 is constructed to have a shape that substantially corresponds to a shape of the orifice 260. For example, in one embodiment, both the orifice 260 and the sealing member 290 are substantially cylindrical, with the sealing member 290 having a larger outer diameter. Such a configuration may facilitate the sealing member 290 covering the orifice 260 in its entirety to enable a seal to be formed between the sealing member 290 and the valve seat 270. In other embodiments, the orifice 260 may have any other cross-sectional shape, e.g., star, square, rectangle, polygon, ellipse or an asymmetric shape. In particular embodiments, the valve seat 270 may define a recess size and may be shaped to receive the sealing member 290. In various embodiments, the orifice plate 250 and therefore, the orifice 260 may be formed from a non-wetting (e.g., hydrophobic) material such as silicon or polytetrafluoroethylene (Teflon®). In other embodiments, a non-wetting (e.g., hydrophobic) coating may be disposed on an inner wall or surface of the orifice 260, the fluid outlet formed by the valve seat 270 and the orifice 260, or the external surface of the orifice plate 250. Such coatings may include, for example, polytetrafluoroethylene (Teflon®), nanoparticles, an oleophilic coating or any other suitable coating.

In various embodiments, the spacing member 280 and the sealing member 290 are constructed of the same materials and have equivalent or substantially equivalent thicknesses 320 and 322 (e.g., silicon, SU-8, silicon rubber, polymethylmethacrylate, etc.). In such embodiments, when the actuating beam 240 extends parallel to the orifice plate 250, lower surfaces of the spacing member 280 and the sealing member 290 are aligned with one another. When the actuating beam 240 is placed into a closed position (as described herein), a surface of the sealing member 290 may contact the valve seat 270 to close the fluid outlet formed at the orifice 260 (e.g., a sealing member surface of the sealing member 290 may be configured to extend up to 20 microns beneath a lower surface of the spacing member 280 if the valve seat 270 was not present). The valve seat 270 and the sealing member 290 may be dimensioned such that a sufficient surface area of the sealing member 290 contacts the valve seat 270 when the actuating beam 240 is placed in the closed position (e.g., when an electrical signal is removed from or applied to the actuating beam 240 via the wire bonds 220) to prevent fluid from traveling from the reservoir 300 to the orifice 260. For example, the sealing member 290 may have a larger diameter or a different cross-section than the valve seat 270. In other embodiments, the sealing member 290 may have a smaller diameter or a different cross-section than the valve seat 270. In some embodiments, a compliant material (e.g., a gold layer) may be disposed on a surface of the sealing member 290 that is configured to contact the valve seat 270.

Various aspects of valve assembly 200 are configured to ensure formation of an adequate seal between the valve seat 270 and the sealing member 290. For example, a structural layer 222 disposed on the input fluid manifold 210 may prevent bowing of the orifice plate 250 resulting from stress induced thereon via adhesives coupling components of the micro-valve 230 to one another and the micro-valve 230 to the housing portion 206. In various embodiments, the structural layer 222 is constructed to have a greater rigidity than the orifice plate 250 to perform this function. The structural layer 222 may be constructed of silicon or any other suitable material. As shown, the structural layer 222 may include protruding portions 224 extending from a main portion thereof. The protruding portions 224 may be attached to an upper surface of the input fluid manifold 210 (e.g., at boundaries of the first and second channels 212 and 214). In certain embodiments, the protruding portions 224 are omitted. A seal may be formed at the protruding portions 224 via, for example, an adhesive disposed between the structural layer 222 and the flex circuit 216. The protruding portions 224 may provide clearance above the input fluid manifold 210. Such clearance may facilitate disposal of the encapsulant 218 that covers all points of contact between the wire bond 220 and the flex circuit 216. In some embodiments, the carrier 202 may include the structural layer 222 such that the stiffness is provided by the carrier 202.

In another aspect, the actuating beam 240 may be configured such that a tight seal is formed at the interface between the valve seat 270 and the sealing member 290 when in the closed position. The actuating beam 240 may include at least one layer of piezoelectric material. The layer of piezoelectric material may include lead zirconate titanate (PZT) or any suitable material. The layer of piezoelectric material may have electrodes electrically connected thereto. In various embodiments, wire bonds 220 are attached to the electrodes such that electrical signals from the flex circuit 216 are provided to the layer of piezoelectric material via the electrodes. The electrical signals may cause the actuating beam 240 to move (e.g., bend, turn, etc.) with respect to its default position. In other embodiments, the actuating beam 240 may include a stainless-steel actuating beam (e.g., having a length of approximately 1 mm). In still other embodiments, the actuating beam 240 may include a bimorph beam having two layers of a piezoelectric material disposed on either side of a base layer (e.g., a base silicon layer). An electrical signal (e.g., an electrical voltage) may be applied to either one of the piezoelectric layers so as to urge the actuating beam to bend towards the corresponding piezoelectric layer. The two piezoelectric layers may include the same piezoelectric material or different piezoelectric materials. In particular embodiments, a different electrical signal may be applied to each of the piezoelectric layers so as to cause the piezoelectric layer to bend or curve the actuating beam by a predetermined distance.

As shown, the wire bonds 220 may be attached to the actuating beam 240 at an electrical connection portion 294 thereof. The electrical connection portion 294 may include a wire-bonding pad (e.g., constructed of gold, platinum, rubidium, etc.) conductively connected to at least one electrode within the actuating beam 240. Beneficially, the electrical connection portion 294 may be separated from the cantilevered portion of the actuating beam 240. In other words, the electrical connection portion 294 may be separated from the fluid contained in the valve assembly 200 via seals formed at the points of connection between the input fluid manifold 210 and the actuating beam 240. As a result, the fluid may possess an electrical property that would otherwise interfere with the operation of the valve assembly 200. In some embodiments, the wire bonds 220 and/or the encapsulant 218 may be routed out through an opening provided in the orifice plate 250.

In various embodiments, the actuating beam 240 is configured such that the closed position is its default position. A tuning layer within the actuating beam 240 may be constructed to be in a state of compressive stress to cause a curvature in the actuating beam towards the orifice. As a result of such curvature, the sealing member 290 may contact the valve seat 270, for example, in the absence of any electrical signals applied to the actuating beam 240 to close the fluid outlet. The degree of curvature may be specifically selected to form a tight seal at the interface between the sealing member 290 and the valve seat 270 when the actuating beam 240 is in a default position. Beneficially, such a default seal prevents evaporation of the fluid contained in the valve assembly 200, which may prevent clogging and other defects.

The actuating beam 240, as shown in FIG. 1A, is bent away from the orifice plate 250. The bend may result from application of an electrical signal to the actuating beam 240 (e.g., via the flex circuit 216). For example, the flex circuit 216 may be electrically connected to an external controller supplying electrical signals relayed to the actuating beam 240.

As illustrated by FIG. 1A, application of the electrical signal may cause the actuating beam 240 to temporarily depart from its default position. For example, in various embodiments, the actuating beam 240 moves upward away from orifice 260 such that a portion of a sealing member surface of the sealing member 290 is displaced (e.g., at least 10 microns) from an upper surface of the valve seat 270. As a result, an opening is temporarily formed between the valve seat 270 and the sealing member 290. The opening may provide a pathway for a volume of fluid to enter the orifice 260 to form a droplet at an exterior surface of the orifice plate 250. The droplets may then be deposited onto a substrate to form a pattern determined via the control signals supplied to each of the actuating beams 240 of each of the micro-valves 230 of the valve assembly 200. Alternatively, the opening may provide a pathway for the fluid to be expelled from the orifice 260 as a gas. As will be appreciated, the frequency with which the actuating beam 240 departs from its default position to a position such as the one shown in FIG. 5 may vary depending on the implementation. For example, in one embodiment, the actuating beam 240 oscillates at a frequency of approximately 12 kHz. However, the actuating beam 240 may oscillate at a smaller (e.g., 10 kHz) or larger frequency (e.g., greater than 20 kHz) in other implementations.

Referring now to FIG. 1B, a cross-sectional view of an illustrative valve assembly 200b including a micro-valve 230b is shown, according to an embodiment. As shown, the valve assembly 200b may include a carrier 202b attached to a valve body 298b via an interposer 222b.

The carrier 202b may include an upper portion 204b and a housing portion 206b extending from an edge of the upper portion 204b. A fluid channel 211b may be provided in the upper portion 204b. A septum 208b (e.g., a rubber or foam septum) may be positioned at an inlet of the fluid channel 211b and a filter 213b may be positioned at an outlet of the fluid channel 211b. A cover 203b (e.g., a plastic or glass cover) may be positioned on the carrier 202b such that the septum 208b is positioned between the carrier 202b and the cover 203b, and secured therebetween. An opening 209b may be defined in the cover 203b and may correspond to the inlet of the fluid channel 211b. A fluid connector 10b may be coupled to the cover 203b or the inlet of the fluid channel 211b. The fluid connector 10b may include an insertion needle 12b configured to pierce the septum 208b and be disposed therethrough in the fluid channel 211b. The fluid connector 10b may be configured to pump pressurized fluid (e.g., ink) into an input fluid manifold 210b of the valve assembly 200b via the insertion needle 12b. Furthermore, the filter 213b may be configured to filter particles from the fluid before the fluid is communicated into a reservoir 300b. In some embodiments, the insertion needle 12b may be formed from or coated with a non-wetting (e.g., a hydrophobic material such as polytetrafluoroethylene (Teflon®)). In other embodiments, the insertion needle 12b may include heating elements. Alternatively, or additionally, heating elements may be included in the valve body 298b. In yet other embodiments, an electric current may be provided to the insertion needle 12b so as to heat the insertion needle 12b and, thereby, the fluid flowing therethrough into the reservoir 300b. In still other embodiments, metallic needles or any other heating element may be provided in the input fluid manifold 210b for heating the fluid contained therein. While shown as only including the fluid channel 211b, in some embodiments, the carrier 202b may also define a second fluid channel for allowing the fluid to be drawn out of the carrier 202b (i.e., cause the fluid to be circulated through the carrier 202b).

The housing portion 206b may define a cavity or a boundary within which the valve body 298b is disposed. The valve body 298b may include the input fluid manifold 210b and the micro-valve 230b. As shown, the input fluid manifold 210b and the micro-valve 230b may define the reservoir 300b configured to hold a volume of pressured fluid received from an external fluid supply via the septum 208b. In various embodiments, the pressurized fluid held within the reservoir 300b is a combination of an ink and additional fluids in a liquid state. In addition to ink, the pressurized fluid may include solvents, surfactants, humectants, or other additives to modify properties such as viscosity, surface tension, drying time, or color characteristics. In further embodiments, the fluid may include conductive, semi-conductive, or biological materials. Alternatively, the fluid may be a gas.

The fluid manifold 210b may be formed by a manifold body 310b having any suitable thickness (e.g., 500 microns). As shown, the input fluid manifold 210b may be pre-formed to include a first channel 212b and a second channel 214b. The first channel 212b may be formed to have a width 304b bearing a predetermined relationship to a length 312b of a cantilevered portion 308b of an actuating beam 240b of the micro-valve 230b. The second channel 214b provides an avenue for an electrical connection to be formed between the actuating beam 240b and a flex circuit 216b via wire bonds 220b extending in between.

As shown, the second channel 214b may be substantially filled with an encapsulant 218b. The encapsulant 218b may ensure the maintenance of an adequate electrical connection between the flex circuit 216b and/or any other control circuit and the actuating beams 240b to facilitate providing electrical control signals to the actuating beams 240b to cause movement thereof to open and close the micro-valve 230b. The encapsulant 218b may further protect a wire bond 220b from physical damage or moisture, as previously described herein.

The portion 314b of the input fluid manifold 210b separating the first and second channels 212b and 214b may serve as a barrier preventing fluid contained in the reservoir 300b from reaching the electrical connections. As such, the input fluid manifold 210b may serve as both part of the reservoir 300b for pressured fluid received from an external fluid supply and an insulating barrier between the pressured fluids and any electrical connections contained within valve assembly 200b.

The micro-valve 230b may include an orifice plate 250b attached to the actuating beam 240b. The orifice plate 250b may be substantially planar and include an orifice 260b extending between surfaces thereof. A valve seat 270b may be disposed on an internal surface 316b of the orifice plate 250b proximate to the orifice 260b. The valve seat 270b may define an interior opening 318b substantially aligned with the orifice 260b to create an outlet for pressured fluid contained in the reservoir 300b. In particular embodiments, the valve seat 270b may be excluded. In some embodiments, the orifice plate 250b or any other orifice plate described herein may also be grounded. For example, an electrical ground connector 295b (e.g., a bonding pad such as a gold bond pad) may be provided on the orifice plate 250b and configured to allow the orifice plate 250b to be electrically grounded (e.g., via electrical coupling to a system ground).

The actuating beam 240b may include a base portion 306b and a cantilevered portion 308b. The base portion 306b may extend underneath the portion 314b of the input fluid manifold 210b separating the first and second channels 212b and 214b. As shown, the base portion 306b may include an electrical connection portion 294b in a region that overlaps with the second channel 214b. The electrical connection portion 294b may include an electrode through which an electrical connection is formed with a flex circuit 216b via wire bonds 220b. The cantilevered portion 308b may extend into the reservoir 300b from the portion 314b of the input fluid manifold 210b. As shown, the cantilevered portion 308b may be disposed on a spacing member 280b and, as a result, is spatially separated from the orifice plate 250b.

The cantilevered portion 308b may have a length 312b such that the cantilevered portion 308b extends from a boundary of the reservoir 300b by a predetermined distance. In various embodiments, the predetermined distance is specifically selected such that a portion 292b of the cantilevered portion 308b overlaps the valve seat 270b and the orifice 260b. A sealing member 290b may extend from the portion 292b of the actuating beam 240b overlapping the orifice 260b. In some embodiments, the sealing member 290b is configured to have a shape that substantially corresponds to a shape of the orifice 260b.

The flex circuit 216b may be positioned on the manifold body 310b and the portion 314b of the input fluid manifold 210b and coupled thereto via a first adhesive layer 221b (e.g., SU-8, silicone rubber, glue, epoxy, etc.). An interposer 222b may be positioned between the upper portion 204b of the carrier 202b and the input fluid manifold 210b so as to create a gap between the upper portion 204b and the input fluid manifold 210b via the first adhesive layer 221b. This may allow sufficient space for disposing the encapsulant 218 and may increase the volume of the reservoir 300b. As shown in FIG. 1B, the interposer 222b may be positioned on and coupled to a portion of the flex circuit 216b via a second adhesive layer 223b (e.g., SU-8, silicone, or any other adhesive). Furthermore, the interposer 222b may be coupled to a side wall of the upper portion 204b of the carrier 202b proximate to the micro-valve 230b via a third adhesive layer 225b (e.g., SU-8, silicone, or any other adhesive).

The interposer 222b may be formed from a strong and rigid material (e.g., plastic, silicon, glass, ceramics, etc.) and disposed on the input fluid manifold 210b so as to prevent bowing of the orifice plate 250b resulting from stress induced thereon via adhesives coupling components of the micro-valve 230b to one another and the micro-valve 230b to the housing portion 206b. In various embodiments, the interposer 222b is configured to have a greater rigidity than the orifice plate 250b to perform this function.

In another aspect, the actuating beam 240b is constructed such that a tight seal is formed at the interface between the valve seat 270b and the sealing member 290b when in the closed position. The actuating beam 240b may include at least one layer of piezoelectric material (e.g., lead zirconate titanate (PZT) or any suitable material). The layer of piezoelectric material may have electrodes electrically connected thereto and wire bonds 220b may be attached to the electrodes such that electrical signals from the flex circuit 216b are provided to the layer of piezoelectric material via the electrodes. The electrical signals may cause the actuating beam 240b to move (e.g., bend, turn, etc.) with respect to its default position.

As shown, the wire bonds 220b may be attached to the actuating beam 240b at an electrical connection portion 294b thereof, substantially similar to the wire bonds 220 described with respect to the valve assembly 200 of FIG. 1A. In various embodiments, the actuating beam 240b is configured such that the closed position is its default position, as described in detail with respect to the actuating beam 240 of FIG. 1A.

The actuating beam 240b, as shown in FIG. 1B, is bent towards orifice plate 250b. The bend may result from a mechanical bias applied to the actuating beam 240b. Alternatively, such a bend may result from application of an electrical signal to the actuating beam 240b via the flex circuit 216b. For example, the flex circuit 216b may be electrically connected to a circuit board 215b (e.g., a printed circuit board) extending perpendicular to a longitudinal axis of the actuating beam 240b along a sidewall the carrier 202b. An identification tag 217b (e.g., the identification tag 106) may be positioned between the circuit board 215b and the sidewall of the carrier 202b. An electrical connector 219b may be electrically coupled to the circuit board 215b and configured to electrically connect the flex circuit 216b to an external controller supplying electrical signals relayed to actuating beam 240b via the circuit board 215b.

As illustrated by FIG. 1B, application of the electrical signal may cause a portion of the actuating beam 240b to temporarily depart from its default position. For example, in various embodiments, a portion of the actuating beam 240b moves upward away from orifice 260b such that a portion of a sealing member surface of the sealing member 290b is a predetermined distance (e.g., at least 10 microns) from an upper surface of valve seat 270b, as described in detail with respect to the actuating beam 240 of FIG. 1A.

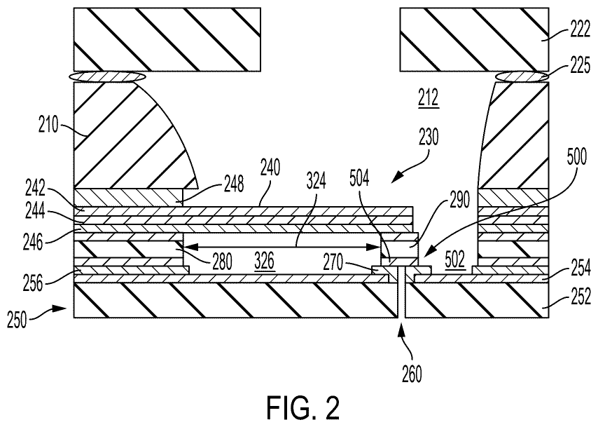

Referring now to FIG. 2, a more detailed view showing various components of the valve assembly 200 described with respect to FIG. 1A is shown, according to an embodiment. As shown, actuating beam 240 includes an actuating portion 242, a tuning layer 244, and a non-active layer 246. The non-active layer 246 may serve as a base for the tuning layer 244 and the actuating portion 242. In some embodiments, the non-active layer 246 is constructed from silicon or other suitable material. In some embodiments, the non-active layer 246, the spacing member 280, and the sealing member 290 are each constructed from the same material (e.g., monolithically formed from a silicon wafer). In an embodiment, the non-active layer 246, the spacing member 280, and the sealing member 290 are formed from a double silicon-on-insulator (DSOI) wafer.

In some aspects, the spacing member 280 includes an intermediate layer interposed between two peripheral layers. In an example embodiment, the intermediate layer and the non-active layer 246 include two silicon layers of a DSOI wafer, with the peripheral layers disposed on either side of the intermediate layer including silicon oxide layers. In this example, the sealing member 290 and the spacing member 280 are formed through etching the surface of the double SOI wafer opposite the actuating portion 242. The oxide layers serve to control or stop the etching process once, for example, the entirety of the intermediate layer forming the spacing member 280 is removed in a region separating the spacing member 280 and sealing member 290. Such a process provides precise control over both the width and thickness of the spacing and the sealing members 280 and 290.

As will be appreciated, the size of the sealing member 290 may contribute to the resonance frequency of the actuating beam 240. Larger amounts of material disposed at or near an end of the actuating beam 240 generally may result in a lower resonance frequency of the actuating beam. Additionally, larger amounts of material may affect the default curvature of the actuating beam 240 that is induced by pressurized fluid contacting the actuating beam 240. Accordingly, the desired size of sealing member 290 may impact various other design choices of the actuating beam 240. In some embodiments, the sealing member 290 is sized based on the dimensions of the orifice 260. In some embodiments, the sealing member 290 is substantially cylindrical and has a diameter approximately 1.5 times that of the orifice 260. For example, in one embodiment, the sealing member 290 has a diameter of approximately 90 microns while the orifice 260 has a diameter of approximately 60 microns. Such a configuration facilitates alignment between the sealing member 290 and the orifice 260 such that the sealing member 290 completely covers the orifice 260 upon contacting the valve seat 270. In another embodiment, the sealing member 290 is sized such that it has a surface area that approximately doubles that of the orifice 260. Such an embodiment may provide greater tolerance for aligning the sealing member 290 and the orifice 260 to facilitate creating a seal between the valve seat 270 and the sealing member 290. In other embodiments, the diameter of the sealing member 290 may be 2 times, 2.5 times, 3 times, 3.5 times or 4 times the diameter of the orifice 260. In various embodiments, a ratio of the diameter of the sealing member 290 to a diameter of the orifice 260 may be in range of 1:1 to 15:1. The ratio may influence the shape, size and/or volume of a fluid droplet ejected through the orifice 260. The ratio for a particular embodiment may be selected based on a particular application for which it is intended to be used.

Beneficially, the gap 324 between the spacing member 280 and the sealing member 290 creates a volume of separation 326 between the actuating beam 240 and the orifice plate 250. The volume of separation 326 prevents squeeze film damping of oscillations of the actuating beam 240. In other words, insufficient separation between the orifice plate 250 and the actuating beam 240 may lead to drag resulting from fluid having to enter and/or exit the volume of separation 326 as the actuating beam 240 opens and closes the orifice 260. Having the greater volume of separation produced through the use of the spacing member 280 may reduce such drag and may therefore facilitate the actuating beam 240 oscillating at faster frequencies.

With continued reference to FIG. 2, the orifice plate 250 may include a base layer 252 and an intermediate layer 254. For example, in one embodiment, the base layer 252 includes a silicon layer, and the intermediate layer 254 includes a silicon oxide layer. In the embodiment shown, a portion of the intermediate layer 254 proximate to the orifice 260 may be removed and a first portion of the valve seat 270 may be disposed directly on the base layer 252. A second portion of the valve seat 270 may be disposed on the intermediate layer 254. It should be understood that, in alternative embodiments, the intermediate layer 254 extends all the way to boundaries of the orifice 260 and the valve seat 270 is disposed on the intermediate layer 254. In still other embodiments, the removed portion of the intermediate layer 254 may have a cross-section equal to or greater than a cross-section of the valve seat 270 such that the valve seat 270 is disposed entirely on the base layer 252.

Due to the criticality of the spatial relationship between the spacing member 280 and the valve seat 270, attachment of the spacing member 280 to the orifice plate 250 may be performed in a manner allowing precise control over the resulting distance between the actuating beam 240 and the orifice plate 250. As shown, an adhesive layer 256 may be used to attach the spacing member 280 to the orifice plate 250. In various embodiments, a precise amount of epoxy-based adhesive (e.g., SU-8, polymethylmethacrylate, silicone, etc.) is applied to the base layer 252 or intermediate layer 254 prior to placement of the combination of the spacing member 280 and the actuating beam 240 thereon. The adhesive may be cured to form an adhesive layer 256 having a precisely controlled thickness. For example, in some embodiments, a lower-most surface of the spacing member 280 is substantially aligned with an upper surface of the valve seat 270. Any desired relationship between such surfaces may be obtained to create a relationship between the sealing member 290 and the valve seat 270 that creates an adequate seal when the actuating beam 240 is in the default position. In various embodiments, the adhesive layer 256 and the valve seat 270 may be formed from the same material (e.g., SU-8 or gold) in a single photolithographic process.

In the example shown with respect to FIG. 2, the micro-valve 230 includes a sealing structure 500 including various components through which a seal is formed to separate the orifice 260 from a volume 502 proximate the actuating beam 240. In the example shown, the sealing structure 500 includes the sealing member 290 and the valve seat 270. As described herein, the actuating beam 240 may be configured such that an orifice-facing surface 504 of the sealing member 290 contacts an upper surface of the valve seat 270 to form a seal at the interface between the valve seat 270 and the sealing member 290. The seal isolates the orifice 260 from the volume 502 such that minimal or no fluid escapes the valve assembly 200 when no electrical signals are applied to the actuating beam 240 (e.g., when the micro-valve 230 is configured as normally closed). Several alternatives to the sealing structure 500 are described in more detail herein. In other embodiments, the valve seat 270 may be excluded such that the orifice facing surface of the sealing structure 500 contacts the orifice plate 250 so as to fluidically seal the orifice 260.

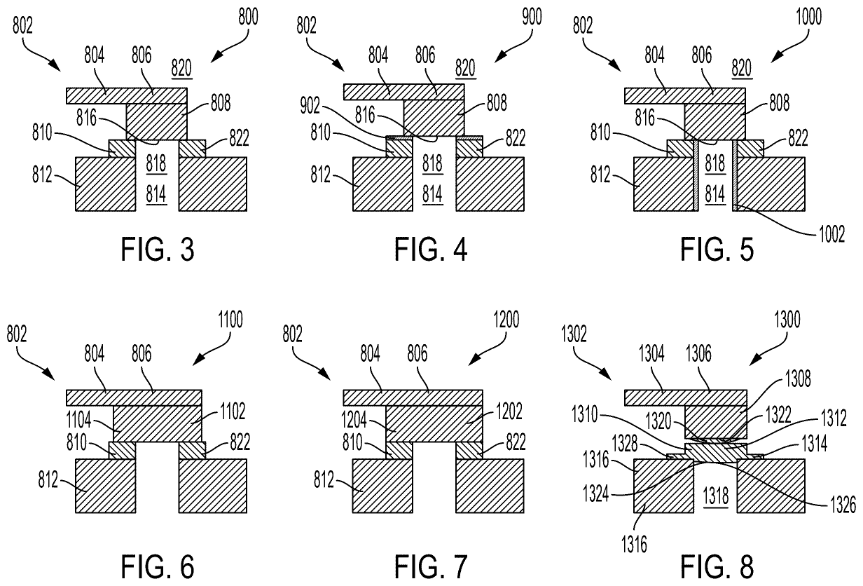

The valve assemblies, micro-valves, and related components described with respect to FIGS. 3-8 may be implemented according to any of the embodiments described previously. Referring now to FIG. 3, a cross-sectional view of an illustrative sealing structure 800 of a micro-valve is shown, according to an embodiment. For example, the sealing structure 800 may be an example of the sealing structure 500 described with respect to FIG. 2. As shown, an actuating beam 802 may include a cantilevered portion 804. The cantilevered portion 804 may extend from a base portion disposed on a spacing member. The spacing member may be disposed on an orifice plate 812 that includes an orifice 814. The cantilevered portion 804 may extend from the base portion towards the orifice 814 such that an overlapping portion 806 thereof overlaps the orifice 814.

The sealing structure 800 may include a sealing member 808 disposed at the overlapping portion 806 and a valve seat 810 disposed on the orifice plate 812. The sealing member 808 may extend towards the orifice 814 such that an orifice-facing surface 816 contacts an upper surface 822 of the valve seat 810. The valve seat 810 may surround the orifice 814 and define an opening 818. In the example shown, the opening 818 is aligned with the orifice 814. In other words, the opening 818 and the orifice 814 define a fluid outlet having a substantially smooth delimiting surface. In various embodiments, the valve seat 810 is formed of a compliant material such as SU-8 or gold. In other embodiments, the valve seat 810 may be formed from silicon. As described herein, the actuating beam 802 may be configured such that it possesses a slight curvature or bias toward the orifice 814 in a default position. As such, the orifice-facing surface 816 presses against the valve seat 810 to form a seal that isolates the orifice 814 from a volume 820 disposed proximate the actuating beam 802.

In the embodiment depicted in FIG. 3, the orifice 814 is cylindrical. In other embodiments, the orifice 814 may have any other suitable shape (e.g., star, square, rectangle, polygon, ellipse, etc.). The valve seat 810 may be substantially annular and have an inner diameter equivalent or substantially equivalent to the diameter of the orifice 814. The valve seat 810 may have an outer diameter greater than the inner diameter of the orifice 814. The sealing member 808 may be formed as a substantially cylindrical pillar or post having a diameter between the inner and outer diameter of the valve seat 810. As shown in FIG. 3, the diameter of the sealing member 808 may be closer to the inner diameter of the valve seat 810 than the outer diameter. The diameter of the sealing member 808 may contribute to the resonance frequency of actuating beam 802 (e.g., by impacting its overall weight and therefore the overall piezoelectric response of the actuating beam 802). Thus, in some implementations, the diameter of the sealing member 808 may be closer to the inner diameter of the orifice 814 to produce a desired resonance frequency when holding the size of the valve seat 810 fixed. However, it should be appreciated that the thickness (i.e., a difference between the inner and outer diameters of the valve seat 810) of the valve seat 810 may change in a radial direction in various alternative embodiments such that the overall positioning of an outer edge of the sealing member 808 with respect to the valve seat 810 may change.

Referring now to FIG. 4, a cross-sectional view of an illustrative sealing structure 900 is shown, according to an embodiment. The sealing structure 900 shares features with the sealing structure 800 described with respect to FIG. 3. As such, FIG. 4 incorporates common reference numerals to indicate the inclusion of such like components.

As shown, in the sealing structure 900, a coating 902 may be disposed on the upper surface 822 of the valve seat 810. In various embodiments, the coating 902 is a hydrophobic elastic material such as CYTOP®, polytetrafluoroethylene (Teflon®), polydimethylsiloxane (PDMS) or any other suitable hydrophobic or oleophilic material. The hydrophobicity of the coating 902 may facilitate the dispersion of water droplets on the valve seat 810 to prevent the amalgamation of particulate matter on the upper surface 822. As such, the coating 902 may promote the long-term durability of the sealing structure 900. Additionally, the coating 902 may add elasticity or complicity to the valve seat 810 to facilitate the formation of the seal at the interface between the orifice-facing surface 816 and the upper surface 822. In some embodiments, the coating 902 may be formed from a compliant material, such as gold.

Referring now to FIG. 5, a cross-sectional view of an illustrative sealing structure 1000 is shown, according to an embodiment. The sealing structure 1000 shares features with the sealing structure 800 described with respect to FIG. 3. As such, FIG. 5 incorporates common reference numerals to indicate the inclusion of such like components. As shown in FIG. 5, in the sealing structure 1000, a coating 1002 is disposed around the internal surface of the fluid outlet defined by the orifice 814 and the opening 818. In some embodiments, the coating 1002 may be constructed from a hydrophobic material such as CYTOP®, polytetrafluoroethylene (Teflon®), PDMS or any other suitable hydrophobic or oleophilic material. The hydrophobicity of the coating 1002 facilitates the formation and travel of droplets within the orifice 814 upon actuation of the actuating beam 802 (e.g., as a result of an electrical signal being applied thereto).

In some embodiments, a sealing structure may include a combination of the coatings 902 and 1002 described with respect to FIGS. 4 and 5. In other words, a sealing structure may include both a coating lining the inner surface of the fluid outlet as well as a coating on the upper surface 822. Beneficially, such an implementation may provide hydrophobicity both within the fluid outlet and the upper surface 822.

Referring now to FIGS. 6 and 7, cross-sectional views of illustrative sealing structures 1100 and 1200 are shown, according to embodiments. The sealing structures 1100 and 1200 share components with the sealing structure 800 described with respect to FIG. 3 and include like reference numerals to indicate the incorporation of such like components.

As shown in FIG. 6, the sealing structure 1100 differs from the sealing structure 800 in that it includes a sealing member 1102 having a larger diameter than the sealing member 808 described with respect to FIG. 3. As such, a side surface 1104 of the sealing member 1102 lies closer to the outer diameter of the valve seat 810 than the inner diameter. Such an arrangement provides greater surface area for contacting the upper surface 822 of the valve seat 810 to form the isolating seal described herein. However, as will be appreciated, the larger-sized sealing member 1102 may contribute to the resonance frequency of the actuating beam 802 and other operational aspects (e.g., drop size, operating frequency, etc.) of any incorporating micro-valve.

As shown in FIG. 7, the sealing structure 1200 differs from the sealing structure 1100 in that it includes a sealing member 1202 having a still larger diameter than the sealing member 1102. An outer surface 1204 of the sealing structure 1200 may be substantially aligned with the outer diameter of the valve seat 810. In other words, the diameter of the sealing member 1202 is substantially equivalent to the outer diameter of the valve seat 810 (e.g., within ±10% of the outer diameter). Such an arrangement provides even more surface area for formation of the isolating seal, with the understanding that such a modification may impact aspects of any incorporating valve assembly's performance in other ways (e.g., operating frequency). In still other embodiments, the diameter of the sealing member 1202 may be larger than the outer diameter of the valve seat 810.

Referring now to FIG. 8, a cross-sectional view of a sealing structure 1300 for a micro-valve is shown, according to an example embodiment. As shown, a cantilevered portion 1304 of an actuating beam 1302 may extend towards an orifice 1318 in an orifice plate 1316. An overlapping portion 1306 of the cantilevered portion 1304 overlaps the orifice 1318. The sealing structure 1300 may include a sealing member 1308 disposed at the overlapping portion 1306 and extending towards the orifice 1318. In various embodiments, the sealing member 1308 is shaped in a manner that corresponds to the orifice 1318. For example, in various embodiments, both the sealing member 1308 and the orifice 1318 are substantially cylindrical, and the orifice 1318 has a smaller diameter than that of the sealing member 1308.

The sealing structure 1300 further includes a stopper 1310 disposed on an orifice-facing surface 1322 of the sealing member 1308. The stopper 1310 may be constructed of a compliant material such as SU-8, PDMS or any other suitable material. As shown, the stopper 1310 may include a narrow portion 1312 attached to the orifice-facing surface 1322 and a wide portion 1314 extending from the narrow portion 1312. The narrow portion 1312 and the wide portion 1314 may each be substantially cylindrical such that the stopper 1310 forms a substantially top hat-shaped structure. In various embodiments, the wide portion 1314 has a cross-sectional area that is greater than that of the narrow portion 1312.

An orifice-facing surface 1324 of the stopper 1310 may include a protrusion 1326 shaped in a manner that corresponds to the orifice 1318. The protrusion 1326 is aligned with the orifice 1318 such that it fits into the orifice 1318 to ensure that a seal is formed when the orifice facing surface 1324 contacts the orifice plate 1316. In FIG. 8, the stopper 1310 is shown to include a portion 1320 disposed on the orifice-facing surface 1322 and a remaining portion 1328 disposed on the orifice plate 1316. The stopper 1310 includes the portion 1320 and the remaining portion 1328 at an intermediate stage of its construction. In various embodiments, after completion of the construction of the stopper 1310, the stopper 1310 is a unitary body extending continuously between orifice-facing surfaces 1322 and 1324.

Similar to the actuating beam 240 described with respect to FIGS. 1A-B, the actuating beam 1302 may be constructed to have a default curvature or bias such that the orifice-facing surface 1324 contacts the orifice plate 1316 and the protrusion 1326 fits into the orifice 1318 to form a seal at the interface between the stopper 1310 and the orifice plate 1316. In other words, the actuating beam 1302 may apply a downward force to create a tight seal as a result of direct contact between the stopper 1310 and the orifice plate 1316. The protrusion 1326 ensures minimal gaps at the interface to form a tight seal.

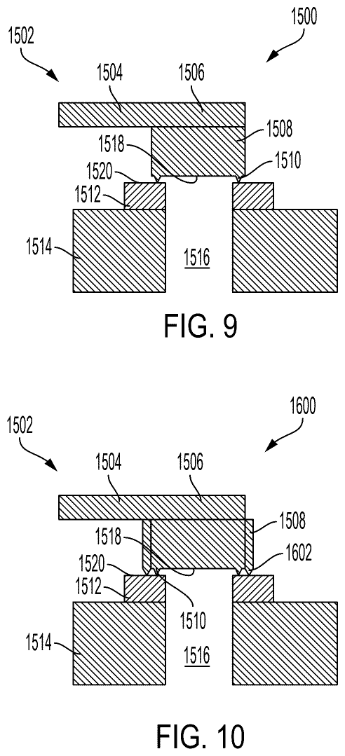

Referring now to FIG. 9, a cross-sectional view of a sealing structure 1500 for a micro-valve is shown, according to an example embodiment. As shown, a cantilevered portion 1504 of an actuating beam 1502 may extend towards an orifice 1516 of an orifice plate 1514. An overlapping portion 1506 of the cantilevered portion 1504 may overlap the orifice 1516. The sealing structure 1500 may include a sealing member 1508 disposed at the overlapping portion 1506 and extending toward the orifice 1516. In various embodiments, the sealing member 1508 is shaped in a manner that corresponds to the orifice 1516. For example, in various embodiments, both the sealing member 1508 and the orifice 1516 are substantially cylindrical, and the orifice 1516 has a smaller diameter than that of the sealing member 1508.

The sealing structure 1500 may include a valve seat 1512. The valve seat 1512 may surround the orifice 1516 and define an opening that is aligned with the orifice 1516 to define a fluid outlet. In various embodiments, the valve seat 1512 is formed of a compliant material such as SU-8. In other embodiments, the valve seat 1512 is formed from a non-compliant material, for example, glass, silicon, or gold. As shown, a sealing blade or protrusion 1510 may extend from an orifice-facing surface 1518 of the sealing member 1508. The sealing blade 1510 may be shaped in a manner that corresponds to a perimeter of the sealing member 1508. In some embodiments, the sealing blade 1510 is substantially annular and has inner and outer diameters that fall between the inner diameter and the outer diameter of the valve seat 1512. The sealing blade 1510 may extend towards an upper surface 1520 of the valve seat 1512 and may contact the valve seat 1512 when the actuating beam 1502 is placed in a default position. The sealing blade 1510 may provide a focal point for the downward force supplied by the actuating beam 1502 such that a tight seal is formed at the interface between a tip of the sealing blade 1510 and the valve seat 1512. In some embodiments, the sealing blade 1510 or any other sealing blade defined herein, may have a flat or rounded tip.

Referring now to FIG. 10, a cross-sectional view of a sealing structure 1600 is shown, according to an example embodiment. The sealing structure 1600 may include similar components to the sealing structure 1500 described with respect to FIG. 9 and includes like reference numerals to indicate the incorporation of such like components. The sealing structure 1600 may differ from the sealing structure 1500 described with respect to FIG. 9 in that the sealing structure 1600 may include an additional sealing blade 1602. The additional sealing blade 1602 may be concentric with and surround the sealing blade 1510 such that the sealing blades 1510 and 1602 form concentric rings that contact the upper surface 1520. In other embodiments, the sealing blades 1510 and 1602 may be non-concentric with the orifice or have non-circular cross-sections (e.g., oval, elliptical, polygonal, asymmetric, etc.) The additional sealing blade 1602 may increase the contact area between the sealing member 1508 and the valve seat 1512. Not only may the increased contact area improve the quality of the seal formed at the interface between the valve seat 1512 and the sealing blades 1510 and 1602, but it may also render the sealing structure 1600 more effective at dealing with particulate matter that may become lodged between the sealing member 1508 and the valve seat 1512. Additionally, the additional sealing blade 1602 may improve the ruggedness of the sealing structure 1600 because the additional sealing blade 1602 may serve as a backup point of contact with the valve seat 1512. In other words, if the sealing blade 1510 is destroyed at a particular circumferential point, the additional sealing blade 1602 may still form a seal at that point to render the sealing structure 1600 operable.

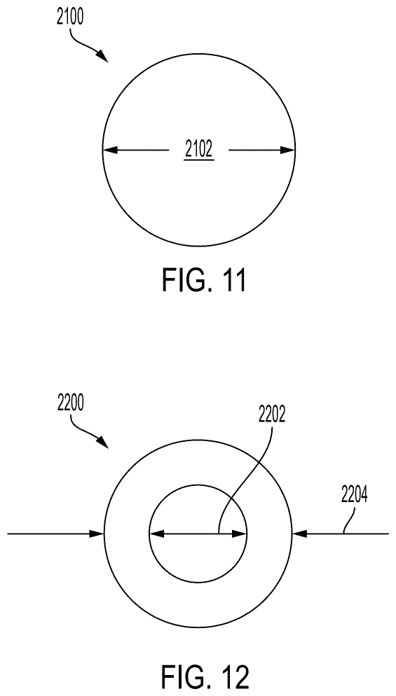

Referring now to FIG. 11, a cross-sectional view of a sealing member 2100 of a micro-valve is shown, according to an embodiment. The sealing member 2100 may be an example embodiment of the sealing member 808 contained in the sealing structure 800 described with respect to FIG. 3 or any of the sealing structures described herein. As shown, the sealing member 2100 may be substantially cylindrical and may have a diameter 2102. The diameter 2102 may be selected based on a size of an orifice in an orifice plate.

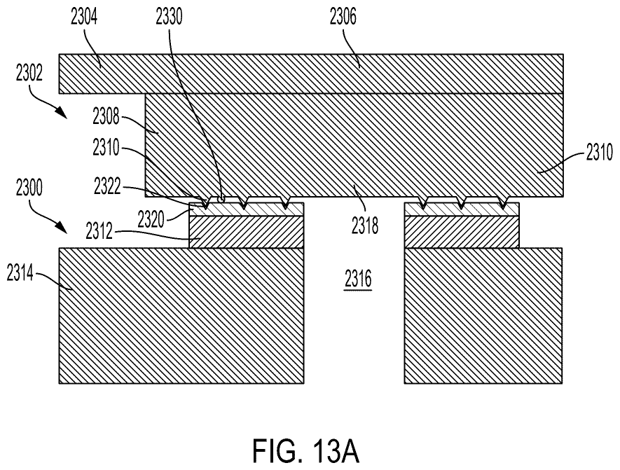

Referring now to FIG. 12, a cross-sectional view of a valve seat 2200 of a micro-valve is shown, according to an embodiment. The valve seat 2200 may be an embodiment of the valve seat 810 contained in the sealing structure 800 described with respect to FIG. 3 or any of the other sealing structures described herein. As shown, the valve seat 2200 may be annular-shaped and include an inner diameter 2202 and an outer diameter 2204. The inner and outer diameters 2202 and 2204 may define a range within which a diameter of a sealing member is contained. For example, in an embodiment where the sealing member 2100 described with respect to FIG. 11 is used in conjunction with the valve seat 2200, the diameter 2102 may be selected such that it is greater than the inner diameter 2202. In some embodiments, the diameter 2102 is between the inner and outer diameters 2202 and 2204. In some embodiments, the diameter 2102 is equal to the outer diameter 2204, and the micro-valve is constructed such that the sealing member 2100 is substantially aligned with the valve seat 2200 such that an outer surface of the sealing member aligns with an outer surface of the valve seat 2200. In some embodiments, the diameter 2102 is greater than the outer diameter 2204 such that an outer edge of the sealing member 2100 overhangs the valve seat in the assembled micro-valve.

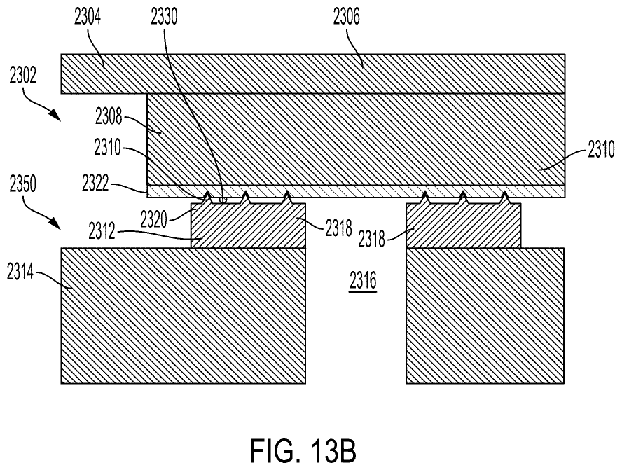

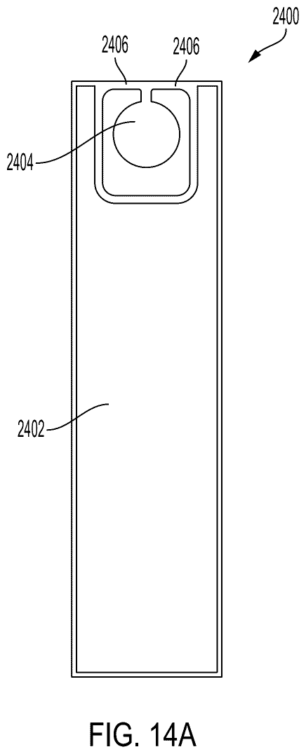

Referring now to FIG. 13A, a cross-sectional view of an illustrative sealing structure 2300 for a micro-valve is shown, according to an embodiment. As shown, a cantilevered portion 2304 of an actuating beam 2302 may extend towards an orifice 2316 of an orifice plate 2314. An overlapping portion 2306 of the cantilevered portion 2304 may overlap the orifice 2316. The sealing structure 2300 may include a sealing member 2308 disposed at the overlapping portion 2306 and extending toward the orifice 2316. In various embodiments, the sealing member 2308 is shaped in a manner that corresponds to the orifice 2316. For example, in various embodiments, both the sealing member 2308 and the orifice 2316 are substantially cylindrical, and the orifice 2316 has a smaller diameter than that of the sealing member 2308.

The sealing structure 2300 may also include a valve seat 2312. The valve seat 2312 may surround the orifice 2316 and define an opening that is aligned with the orifice 2316 to define a fluid outlet. In various embodiments, the valve seat 2312 is formed of a compliant material such as a negative photoresist (e.g., SU-8, silicon, or gold). As shown, a plurality of sealing blades or protrusions 2310 may extend from an orifice-facing surface 2318 of the sealing member 2308. The sealing blades 2310 may be shaped in a manner that corresponds to a perimeter of the sealing member 2308 (e.g., concentrically disposed on the orifice-facing surface 2318). In some embodiments, the sealing blades 2310 are substantially annular and have inner and outer diameters that fall between the inner diameter and the outer diameter of the valve seat 2312.

As shown in FIG. 13A, a sealing layer 2320 may be disposed on the valve seat 2312. The sealing layer 2320 may include, for example, a metal layer (e.g., gold or platinum) or any other suitable layer. In various embodiments, a plurality of indents 2322 may be formed on the sealing layer 2320. The plurality of indents 2322 may be formed, for example, via an etching process. The locations of the plurality of indents 2322 may correspond to locations of the plurality of sealing blades 2310. In particular embodiments, the plurality of indents 2322 are formed by cold forging by repeatedly striking the plurality of sealing blades 2310 on the sealing layer 2320 (e.g., periodic application of electric signal to the actuating beam 2302). The sealing blades 2310 may extend towards the sealing layer 2320 and contact a base of the corresponding indent 2322 when the actuating beam 2302 is placed in a default position. A spacing between adjacent sealing blades 2310 and a distance between the orifice-facing surface 2318 and the orifice plate 2314 may be configured to push small particles 2330 (e.g., dust, photoresist debris, etc.) away from the seal formed between the sealing blades 2310 and the valve seat 2312, for example, towards and/or away from the orifice 2316. Furthermore, mating of the plurality of sealing blades 2310 with the corresponding indents 2322 may facilitate formation of a better fluid tight seal between the sealing member 2308 and the valve seat 2312. In particular embodiments, a filter may be positioned in a fluid manifold upstream of the micro-valve including the sealing structure 2300 so as to filter dust or other particulate matter from the fluid.

Referring briefly to FIG. 13B, a cross-sectional view of an illustrative sealing structure 2350 for a micro-valve is shown, according to an embodiment. The sealing structure 2350 may include similar components as disclosed above in reference to FIG. 13A with the locations of the sealing blades 2310 and the corresponding indents 2322 inverted. In other words, the sealing blades 2310 may protrude from the valve seat 2312 to mate with the corresponding indents 2322 in the sealing member 2308.

As described herein, the actuating beam 2302 may include a cantilevered portion 2304 that is configured to bend towards and away from an orifice 2316. By bending the cantilevered portion 2304 towards the orifice 2316, an overlapping portion 2306 of the actuating beam 2302 may be configured to overlap, and thus seal, the orifice 2316. As a result of bending the actuating beam 2302, the overlapping portion 2306 and/or the sealing member 2308 may become angled with respect to the orifice 2316 and/or valve seat 2312 resulting in an insufficient seal.

In some embodiments, the actuating beam 2302 may be gimballed such that a bottom surface of overlapping portion 2306 and/or the sealing member 2308 may adjust to remain parallel to a surface of a surface of the orifice plate 2314 and/or valve seat 2312. The gimbal may further enhance the seal in a closed position, providing a more adaptable and efficient sealing mechanism compared to traditional rigid structures.

The overlapping portion 2306 may be affixed to the remainder of the actuating beam 2302 at either a single point or a plurality of points by ribs, allowing for a range of design options to suit different applications. The gimbaling action of the actuating beam 2302, produced primarily through flexure and/or torsion of the gimbal ribs, may offer improved sealing over traditional micro-valve designs.

By modulating the effective lever arm of the gimbal by adjusting the distance between the ribs and the centerline of the actuating beam, the gimbal may be configured for either larger or smaller gimbal action. As a result, a high degree of control over the sealing process may be achieved, which can lead to improved performance and longevity of the micro-valve. In some embodiments, the gimbal of the actuating beam 2302 may be configured to produce an asymmetric peeling force, which can be advantageous in specific applications.

The present disclosure may be implemented in the printing industry, specifically in inkjet printers, to improve the efficiency and longevity of micro-valves used in a valve assembly. The gimballed cantilevered actuating beam's dynamic and efficient sealing mechanism could enhance the performance of the micro-valves, thereby leading to more precise fluid distribution (e.g., producing higher quality prints).

Furthermore, the ability to modulate the effective lever arm of the gimbal may allow for better control over the fluid flow, potentially reducing fluid wastage. The potential to produce an asymmetric peeling force in some designs may also be advantageous in specific printing applications, offering a novel approach to micro-valve sealing in the printing industry.

Gimballing may refer to a mechanism that allows a portion of the actuating beam to pivot or rotate about a fixed point or axis. This feature may enable the overlapping portion of the actuating beam to adjust its orientation relative to the orifice or valve seat, thereby potentially improving the sealing effectiveness. In some embodiments, the gimballing action may be achieved through the use of flexible ribs or joints that connect the overlapping portion to the rest of the actuating beam. This flexibility may allow the sealing member to maintain better contact with the valve seat or orifice plate even when the actuating beam is bent or deformed. Gimballing may enhance the micro-valve's ability to form a tight seal, adapt to minor misalignments, and potentially increase the overall reliability and performance of the device.

Flexure and torsion are two types of deformation that may occur in the gimballing mechanism of a micro-valve's actuating beam. Flexure primarily involves bending or curving of the ribs or joints, where the material experiences compression on one side and tension on the other, resulting in a change of shape without twisting. This type of deformation allows the overlapping portion to tilt or pivot relative to the rest of the beam. Torsion, on the other hand, involves twisting of the ribs or joints around their longitudinal axis, where different parts of the cross-section rotate relative to each other. This rotational deformation enables the overlapping portion to twist or rotate about an axis, such as an axis perpendicular to the beam's length. In some gimballing designs, a combination of flexure and torsion may be employed to achieve more complex movements, providing greater adaptability and precision in the sealing mechanism of the micro-valve.

The distance between the ribs and the centerline of the sealing member may significantly influence the gimballing action of the actuating beam. By adjusting this distance, the effective lever arm of the gimbal may be modulated, resulting in either larger or smaller gimbal action. In some embodiments, a shorter distance between the ribs and the centerline may produce a more rapid gimballing response, thereby allowing the sealing member to adjust quickly to changes in the actuating beam's position. Conversely, a larger distance may result in a slower, more controlled gimballing action. The distance may be fine-tuned based on the application of the micro-valve.

Lift off and peeling forces may play crucial roles in the operation and performance of micro-valve sealing mechanisms. Lift off forces refer to the upward forces that act on the sealing member when the actuating beam moves from a closed to an open position, effectively breaking the seal and allowing fluid flow. These forces may be influenced by factors such as the actuating beam's stiffness, the applied electrical signal, and the fluid pressure. Peeling forces, on the other hand, are associated with the gradual separation of the sealing member from the valve seat or orifice plate, typically starting from one edge and progressing across the sealing interface. In some micro-valve designs, asymmetric peeling forces may be intentionally introduced to enhance the sealing or opening characteristics. The interplay between lift off and peeling forces can significantly impact the micro-valve's response time, sealing effectiveness, and overall reliability, making their consideration and control essential in optimizing micro-valve performance for various applications.

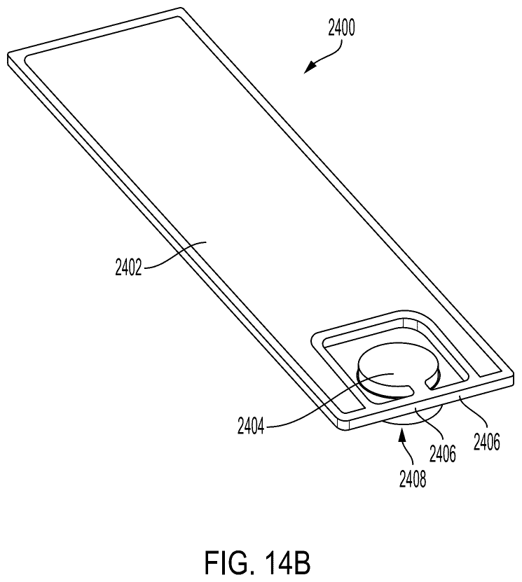

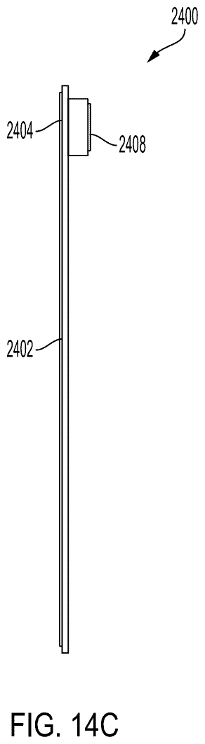

Referring to FIGS. 14A-14C, an illustrative asymmetrically gimballed cantilevered actuating beam 2400 is depicted. In FIG. 14A, the asymmetrically gimballed cantilevered actuating beam 2400 is depicted in a top-down view. In FIG. 14B, the asymmetrically gimballed cantilevered actuating beam 2400 is depicted in an isometric view. In FIG. 14C, the asymmetrically gimballed cantilevered actuating beam 2400 is depicted in a side view. The actuating beam 2400 may include a cantilevered portion 2402 that is configured to bend towards and away from an orifice in a micro-valve assembly. In some embodiments, the cantilevered portion 2402 may bend in response to the input of an electrical signal to a piezoelectrical material in the cantilevered portion 2402. At the end of the actuating beam 2400 is an overlapping portion 2404 that is configured to overlap with the orifice. The overlapping portion 2404 is affixed at a single point by one or more ribs 2406. The gimbaling action of the actuating beam 2400 may be primarily produced through flexure and/or torsion of the one or more ribs 2406.

In some embodiments, the one or more ribs 2406 flexibly affix the overlapping portion 2404 to the remainder of the actuating beam 2400 including the cantilevered portion 2402. This configuration allows the overlapping portion 2404 to gimbal with respect to the remainder of the actuating beam 2400.

In some aspects, the overlapping portion 2404 interfaces with a sealing member 2408. The sealing member 2408 is configured to extend towards the orifice and seal the orifice when the actuating beam 2400 is in a closed position.

In various embodiments, the one or more ribs 2406 may include one or more curved or straight elements. The shape of the ribs may be designed to optimize the gimbaling action of the actuating beam 2400. For example, curved elements may provide additional flexibility and allow for smoother gimbaling motion, while straight elements may offer more precise control over the movement of the overlapping portion 2404. In some cases, a combination of curved and straight elements may be used to achieve specific gimbaling characteristics tailored to the requirements of the micro-valve application. The geometry of the one or more ribs 2406 may also be configured to distribute stress more evenly, thereby potentially increasing the longevity and reliability of the micro-valve assembly.

Although a single affixation point of the one or more gimbal ribs 2406 is depicted in FIGS. 14A-14C at a distal end of the actuating beam 2400, alternative locations of the single affixation point are considered. For example, the affixation point may be located at the proximal end of the overlapping portion 2404. Alternatively, the single affixation point may be located at any other location on the overlapping portion 2404.

In the asymmetrically gimballed cantilevered actuating beam 2400, the peeling forces may be asymmetric about the center of the sealing member 2408 due to the off-center positioning of the ribs 2406. This asymmetry may cause the sealing member 2408 to disengage from the orifice or valve seat in a non-uniform manner, thereby initiating the separation from one edge and progressing across the sealing interface. Such asymmetric peeling may be beneficial in several ways. It may reduce the initial force required to break the seal, thereby potentially improving the micro-valve's response time and energy efficiency. The lower force may further improve the lifespan of the micro-valve. The gradual separation may also help in controlling fluid flow more precisely during the opening phase. Additionally, asymmetric peeling forces may assist in dislodging any particles that might have accumulated at the sealing interface, thereby potentially enhancing the micro-valve's self-cleaning capabilities and long-term reliability.

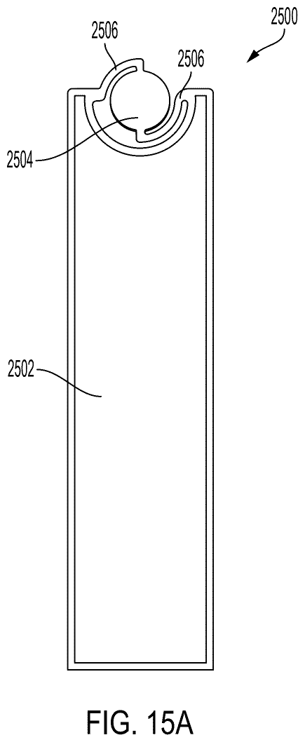

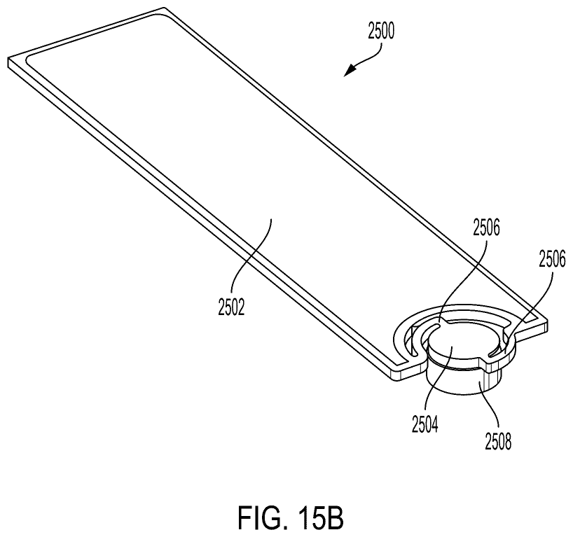

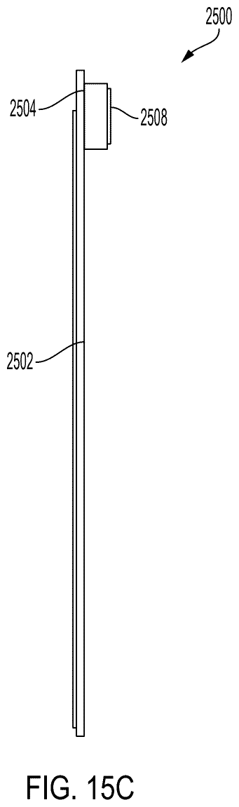

Referring to FIGS. 15A-15C, an illustrative symmetrically gimballed cantilevered actuating beam 2500 is depicted. In FIG. 15A, the symmetrically gimballed cantilevered actuating beam 2500 is depicted in a top-down view. In FIG. 15B, the symmetrically gimballed cantilevered actuating beam 2500 is depicted in an isometric view. In FIG. 15C, the symmetrically gimballed cantilevered actuating beam 2500 is depicted in a side view. The actuating beam 2500 may include a cantilevered portion 2502 that is configured to bend towards and away from an orifice in a micro-valve assembly. In some embodiments, the cantilevered portion 2502 may bend in response to the input of an electrical signal to a piezoelectrical material in the cantilevered portion 2502. At the end of the actuating beam 2500 is an overlapping portion 2504 that is configured to overlap with the orifice. The overlapping portion 2504 may be affixed at two points by ribs 2506. The gimbaling action of the actuating beam 2500 may be primarily produced through flexure of the gimbal ribs 2506. Although two ribs 2506 are illustrated in FIGS. 15A-15C, the inclusion of additional ribs 2506 is also considered. For example, a plurality of ribs 2506 may be affixed at various locations on the end of the cantilevered portion 2502, which in turn affix to the overlapping portion 2504 at two points. Alternatively, a plurality of ribs 2506 may be affixed at two points on the end of the cantilevered portion 2502, which in turn affix to the overlapping portion 2504 at various locations.

In some embodiments, the ribs 2506 flexibly affix the overlapping portion 2504 to the remainder of the actuating beam 2500 including the cantilevered portion 2502. This configuration allows the overlapping portion 2504 to gimbal with respect to the remainder of the actuating beam 2500.

In some aspects, the overlapping portion 2504 is affixed with a sealing member 2508 on a surface facing the orifice. The sealing member 2508 is configured to extend towards the orifice and seal the orifice when the actuating beam 2500 is in a closed position.

In various embodiments, the ribs 2506 may include one or more curved or straight elements. The shape of the ribs may be designed to optimize the gimbaling action of the actuating beam 2500. For example, curved elements may provide additional flexibility and allow for smoother gimbaling motion, while straight elements may offer more precise control over the movement of the overlapping portion 2504. In some cases, a combination of curved and straight elements may be used to achieve specific gimbaling characteristics tailored to the requirements of the micro-valve application. The geometry of the ribs 2506 may also be configured to distribute stress more evenly, thereby potentially increasing the longevity and reliability of the micro-valve assembly.

Although the two affixation points of the gimbal ribs 2506 are depicted in FIGS. 15A-15C at particular locations on actuating beam 2500, alternative locations of the two affixation points are considered. For example, the two affixation points may be swapped. Alternatively, the two affixation points may be relocated to any other location on the overlapping portion 2504.

In the symmetrically gimballed cantilevered actuating beam 2500, the gimballing and lift off forces are symmetric about the center of the sealing member 2508. This symmetry arises from the central positioning of the single affixation point of the ribs 2506 relative to the overlapping portion 2504. As the actuating beam 2500 moves, the forces acting on either side of the sealing member 2508 are balanced, thereby resulting in an even distribution of stress and uniform gimballing action. This symmetry ensures that the sealing member 2508 maintains a parallel orientation with respect to the orifice or valve seat during both opening and closing operations. The balanced forces also contribute to a consistent lift off action, where the sealing member 2508 disengages from the orifice evenly across its surface. This symmetric design may lead to more predictable and reliable micro-valve performance, which may reduce wear and extend the operational lifespan of the micro-valve.

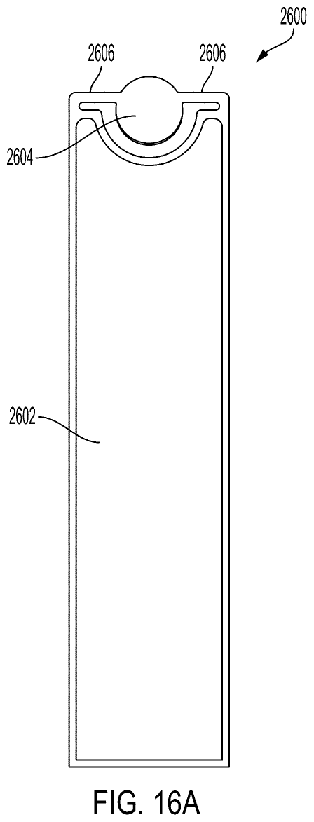

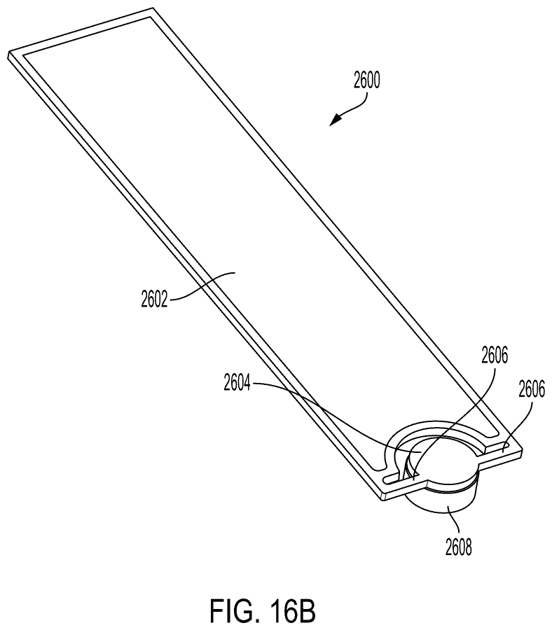

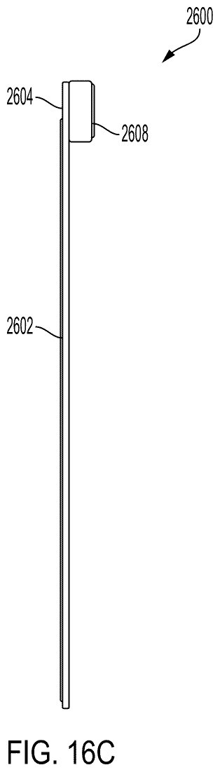

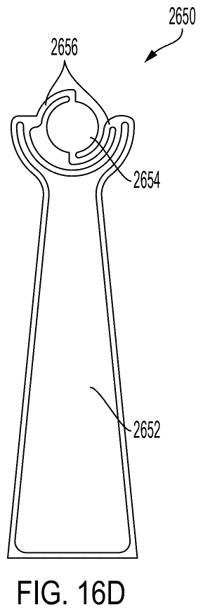

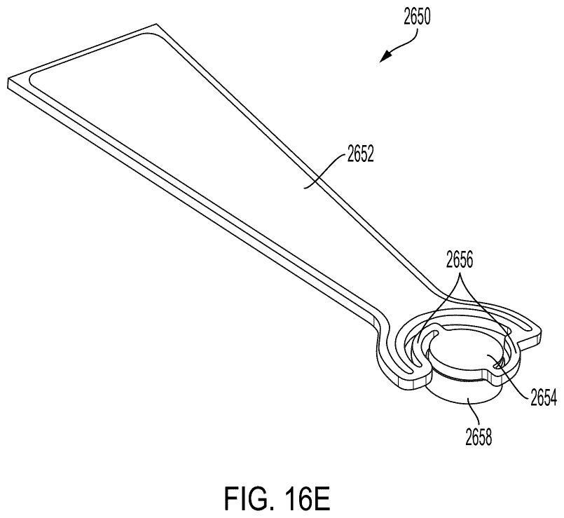

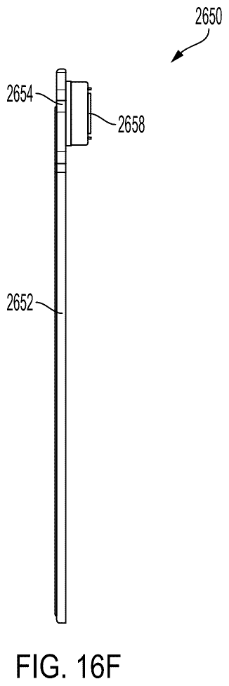

Referring to FIGS. 16A-16C, an illustrative torsion gimballed cantilevered actuating beam 2600 is depicted. In FIG. 16A, the torsion gimballed cantilevered actuating beam 2600 is depicted in a top-down view. In FIG. 16B, the torsion gimballed cantilevered actuating beam 2600 is depicted in an isometric view. In FIG. 16C, the torsion gimballed cantilevered actuating beam 2600 is depicted in a side view. The actuating beam 2600 may include a cantilevered portion 2602 that is configured to bend towards and away from an orifice in a micro-valve assembly. In some embodiments, the cantilevered portion 2602 may bend in response to the input of an electrical signal to a piezoelectrical material in the cantilevered portion 2602. At the end of the actuating beam 2600 is an overlapping portion 2604 that is configured to overlap with the orifice. The overlapping portion 2604 may be affixed at two points by ribs 2606. The gimbaling action of the actuating beam 2600 may be primarily produced through torsion of the gimbal ribs 2606. Although two ribs 2606 are illustrated in FIGS. 16A-16C, the inclusion of additional ribs 2606 is also considered. For example, a plurality of ribs 2606 may be affixed at various locations on the end of the cantilevered portion 2602, which in turn affix to the overlapping portion 2604 at two points. Alternatively, a plurality of ribs 2606 may be affixed at two points on the end of the cantilevered portion 2602, which in turn affix to the overlapping portion 2604 at various locations.

In some embodiments, the ribs 2606 flexibly affix the overlapping portion 2604 to the remainder of the actuating beam 2600 including the cantilevered portion 2602. This configuration allows the overlapping portion 2604 to gimbal with respect to the remainder of the actuating beam 2600.

In some aspects, the overlapping portion 2604 is affixed with a sealing member 2608 on a surface facing the orifice. The sealing member 2608 is configured to extend towards the orifice and seal the orifice when the actuating beam 2600 is in a closed position.

In various embodiments, the ribs 2606 may include one or more curved or straight elements. The shape of the ribs may be designed to optimize the gimbaling action of the actuating beam 2600. For example, curved elements may provide additional flexibility and allow for smoother gimbaling motion, while straight elements may offer more precise control over the movement of the overlapping portion 2604. In some cases, a combination of curved and straight elements may be used to achieve specific gimbaling characteristics tailored to the requirements of the micro-valve application. The geometry of the ribs 2606 may also be configured to distribute stress more evenly, thereby potentially increasing the longevity and reliability of the micro-valve assembly.

Although the two affixation points of the gimbal ribs 2606 are depicted in FIGS. 16A-16C at particular locations on actuating beam 2600, alternative locations of the two affixation points are considered. For example, the two affixation points may be swapped. Alternatively, the two affixation points may be relocated to any other location on overlapping portion 2604. In some embodiments, it may be advantageous for the affixation points to be located on an axis perpendicular to a primary axis of the actuating beam.

By adjusting the affixation point of the ribs 2606 to the overlapping portion 2604 the effective lever arm of the gimbal may be modulated, thus producing configurable larger or smaller gimbal action, as described herein.

In the torsion gimballed cantilevered actuating beam 2600, the peeling forces may be asymmetric about the center of the sealing member 2608 due to the off-center positioning of the ribs 2606. This asymmetry may cause the sealing member 2608 to disengage from the orifice or valve seat in a non-uniform manner, thereby initiating the separation from one edge and progressing across the sealing interface. Such asymmetric peeling may be beneficial in several ways. It may reduce the initial force required to break the seal, thereby potentially improving the micro-valve's response time and energy efficiency. The lower force may further improve the lifespan of the micro-valve. The gradual separation may also help in controlling fluid flow more precisely during the opening phase. Additionally, asymmetric peeling forces may assist in dislodging any particles that might have accumulated at the sealing interface, thereby potentially enhancing the micro-valve's self-cleaning capabilities and long-term reliability.

Referring to FIGS. 16D-16F, an illustrative symmetrically gimballed trapezoidal cantilevered actuating beam 2650 is depicted. In FIG. 16D, the symmetrically gimballed trapezoidal cantilevered actuating beam 2650 is depicted in a top-down view. In FIG. 16E, the symmetrically gimballed trapezoidal cantilevered actuating beam 2650 is depicted in an isometric view. In FIG. 16F, the symmetrically gimballed trapezoidal cantilevered actuating beam 2650 is depicted in a side view. The actuating beam 2650 may include a cantilevered portion 2652 that is configured to bend towards and away from an orifice in a micro-valve assembly. In some embodiments, the cantilevered portion 2652 may bend in response to the input of an electrical signal to a piezoelectrical material in the cantilevered portion 2652. At the end of the actuating beam 2650 is an overlapping portion 2654 that is configured to overlap with the orifice. The overlapping portion 2654 may be affixed at two points by ribs 2656. The gimbaling action of the actuating beam 2650 may be primarily produced through flexure of the gimbal ribs 2656. Although two ribs 2656 are illustrated in FIGS. 16D-16F, the inclusion of additional ribs 2656 is also considered. For example, a plurality of ribs 2656 may be affixed at various locations on the end of the cantilevered portion 2652, which in turn affix to the overlapping portion 2654 at two points. Alternatively, a plurality of ribs 2656 may be affixed at two points on the end of the cantilevered portion 2652, which in turn affix to the overlapping portion 2654 at various locations.

In some aspects, the overlapping portion 2654 is affixed with a sealing member 2658 on a surface facing the orifice. The sealing member 2658 is configured to extend towards the orifice and seal the orifice when the actuating beam 2650 is in a closed position.

The ribs may function similarly as described above in reference to FIGS. 15A-15C.

In plan view, the cantilevered beam may have one or a combination of the following shapes: rectangular, trapezoidal, polygon and curvilinear. In some embodiments, a trapezoidal beam configuration may offer several advantages over other beam geometries. The tapered design of a trapezoidal beam may provide improved stress distribution along the length of the cantilevered portion, reducing stress concentrations that could lead to fatigue or failure. The wider base section may enhance the structural integrity and stiffness of the beam near the anchor point, while the narrower tip section may reduce the mass at the free end, improving the dynamic response characteristics and resonant frequency of the actuating beam.

The trapezoidal geometry may also facilitate more efficient actuation by optimizing the distribution of piezoelectric material along the beam length. In some cases, the varying width may allow for better control of the beam's bending profile, enabling more precise positioning. The reduced tip width may also minimize the footprint of the overlapping portion, allowing for higher density arrangements of multiple micro-valves in an array configuration.

The varying cross-section of a trapezoidal beam may also contribute to improved fluid dynamics around the beam during operation, potentially reducing unwanted fluid interactions that could affect valve performance. In some aspects, the trapezoidal configuration may offer enhanced flexibility in tuning the mechanical properties of the beam to match specific application requirements while maintaining structural robustness.

While the embodiments described herein include actuating beams with one or two ribs, it is to be understood that other embodiments may include a plurality of ribs. For instance, a single rib can be replaced by multiple smaller ribs. This arrangement of multiple ribs can provide additional flexibility and control over the gimbaling action, thereby allowing for fine-tuning of the beam's movement and the force applied to the sealing member. In some aspects, the plurality of ribs may be designed to provide specific gimbaling characteristics, such as varying the rate of gimbal action or enhancing the beam's responsiveness to control signals. This flexibility in design allows for the optimization of the micro-valve's performance for a wide range of applications and operating conditions.

In some embodiments, the ribs traditionally used to facilitate the gimbaling action of the actuating beam may be replaced or augmented by a flexible film or membrane, which similarly allows for gimbaling. This flexible film or membrane may be attached to the overlapping portion of the actuating beam, thereby providing a continuous surface that supports the gimbaling motion while also potentially reducing the complexity of the micro-valve assembly. The use of a flexible film or membrane may offer enhanced durability and may simplify the manufacturing process because the film may be easier to produce and integrate than discrete ribs. Moreover, the inherent flexibility of the film or membrane may provide a more uniform distribution of stress across the gimbaling interface, which may improve the longevity and reliability of the micro-valve's sealing function.

In some embodiments, the ribs themselves may include a layer of piezoelectric material, enabling the ribs to bend in response to an electrical signal. The inclusion of piezoelectric material within the ribs allows for precise control over the gimbaling action of the overlapping portion. When an electrical signal is applied to the piezoelectric layer within the ribs, the material undergoes a change in shape causing the ribs to bend. This bending action may be finely tuned by varying the strength and duration of the electrical signal, thereby allowing for precise adjustments to the position and pressure exerted by the overlapping portion on the orifice.

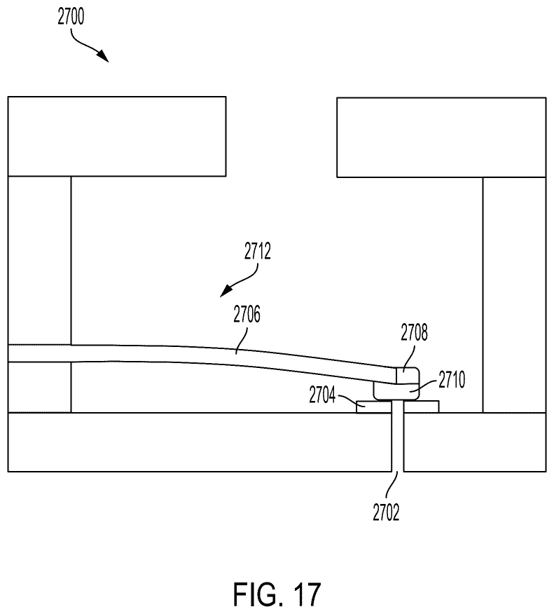

Referring now to FIG. 17, a side view of an illustrative micro-valve assembly 2700 is depicted in accordance with an embodiment. The micro-valve assembly 2700 (e.g., micro-valve 230/230b) may include an orifice plate with a first surface and a second surface. The orifice plate may comprise an orifice 2702 extending from the first surface to the second surface. An actuating beam 2712 (e.g., 2400/2500/2600) may be disposed in spaced relation to the orifice plate. The actuating beam 2712 may include a base portion separated from the orifice plate by a predetermined distance.

A cantilevered portion 2706 of the actuating beam 2712 may extend from the base portion towards the orifice 2702 such that an overlapping portion 2708 thereof overlaps the orifice 2702. The actuating beam 2712 may be movable between a closed position and an open position. The overlapping portion 2708 may be affixed at one or more points by ribs, thereby allowing the overlapping portion 2708 to gimbal with respect to the cantilevered portion 2706.

A sealing member 2710 may be disposed at the overlapping portion 2708. In some embodiments, when the actuating beam 2712 is in the closed position, the cantilevered portion 2706 may be positioned such that a sealing member 2710 seals the orifice 2702 so as to close the micro-valve 2700. The sealing member 2710 may be configured to extend towards the orifice 2702 and seal the orifice 2702 when the actuating beam 2712 is in a closed position. The sealing member 2710, and the associated sealing structure may be configured in various configurations including the embodiments depicted in FIGS. 3-10 or 13.

In some aspects, the ribs flexibly affix the overlapping portion 2708 to the cantilevered portion 2706. This configuration may allow the overlapping portion 2708 to gimbal (e.g., via some combination of flexure and torsion) with respect to the cantilevered portion 2706. The gimbaling action of the actuating beam 2712 may produce an enhanced sealing of the micro-valve 2700.

In some embodiments, the micro-valve 2700 may include a valve seat 2704 configured to interface with the sealing member 2710 in a closed position. The valve seat 2704 may be constructed of a compliant material to facilitate the formation of an enhanced seal resulting from pressure applied due to curvature of the actuating beam.

In certain embodiments, the sealing member 2710 may include one or more additional sealing components (e.g., sealing blades and/or stoppers as described herein).

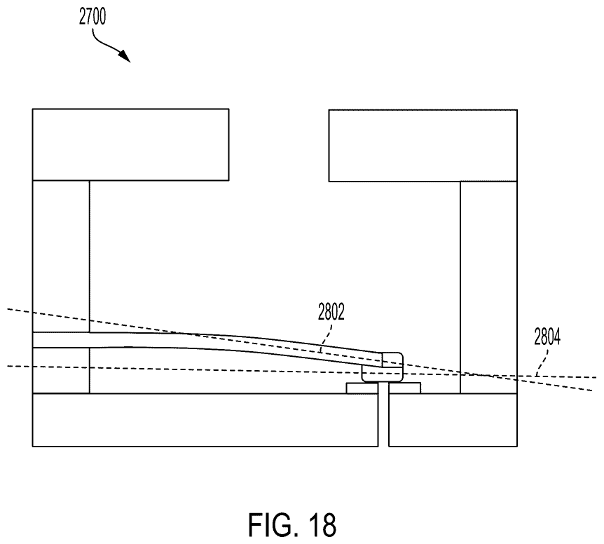

Referring briefly to FIG. 18, a change in the axis 2802 of the cantilevered portion and the axis 2804 of the overlapping portion and/or sealing member as a result of gimballing is illustrated in accordance with an embodiment. By gimballing the overlapping portion and/or the sealing member, the sealing member may be properly aligned with the valve seat to generate an enhanced seal in a closed configuration.

Referring back to FIG. 17, in some embodiments, the valve seat 2704 may be configured to feature an angled surface relative to the orifice plate to better accommodate the bend of the actuating beam 2712 and the resulting angle of the overlapping portion 2708 and/or sealing member 2710 in the closed position. As a result of the angled surface, the amount of gimballing required by the actuating beam 2712 may be lessened and/or removed.

In some embodiments, a mechanical bias may be applied to the overlapping portion 2708 to lessen the amount of gimballing required. This mechanical bias may be achieved through various means, such as incorporating a pre-stressed material in the overlapping portion 2708 or the ribs. The bias may be configured to naturally align the overlapping portion 2708 and sealing member 2710 with the valve seat 2704 or orifice 2702 in the closed position, thereby reducing the need for extensive gimballing. The mechanical bias may improve the sealing efficiency, reduce wear on the gimballing mechanism, and enhance the overall longevity of the micro-valve 2700 assembly.

In some embodiments, the sealing member and valve seat may experience stiction when in intimate contact. Stiction, also known as static friction, may occur between two surfaces that are in close proximity or direct contact, causing them to adhere to each other. Stiction may result from various intermolecular forces, such as van der Waals forces, electrostatic attraction, or surface tension effects. In the context of micro-valves, force stiction may influence the initial force required to separate the sealing member from the valve seat when transitioning from a closed to an open position. In some embodiments, stiction may be reduced by etching features into a contacting surface, thus lowering the contacting surface area.

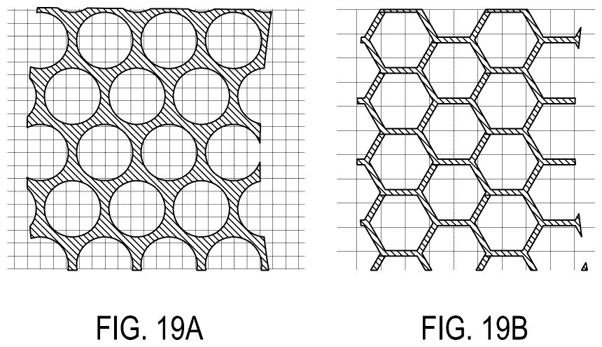

Referring to FIGS. 19A and 19B, illustrative etched features are depicted in accordance with some embodiments. Although the features may have any geometry, circles and hexagons may offer advantages associated with simplified manufacturing and/or greater stiction reduction properties with respect to other geometries.

In certain embodiments, the etched features may be applied beyond the intended contact surfaces to accommodate misalignment of the contact surfaces. The etched features may be sized to facilitate a continuous path around the orifice to prevent leaks when the valve is sealed. For example, the etched features may be sized in relation to the sealing blade to maintain the continuous path.

The etched features may be applied to either of the contacting surfaces. For example, referring to FIG. 13A, the etched features may be applied to sealing layer 2320 or the ends of the sealing blades 2310.

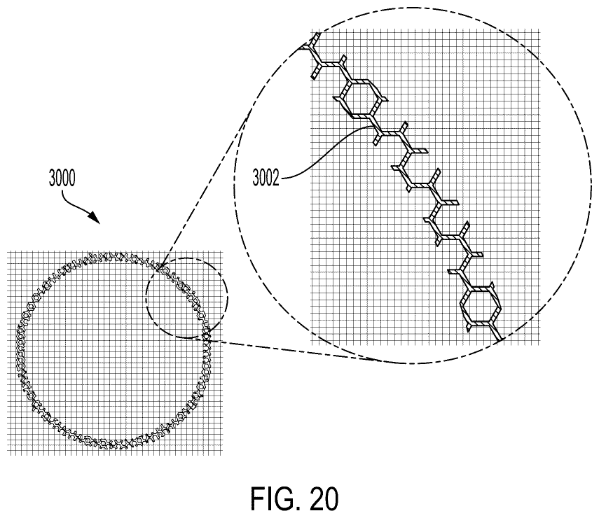

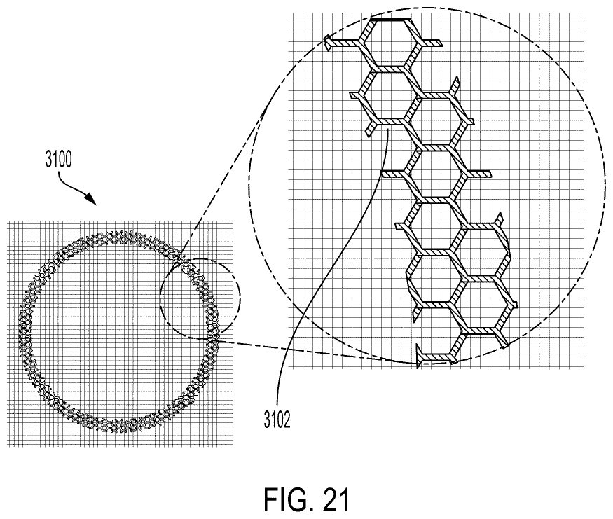

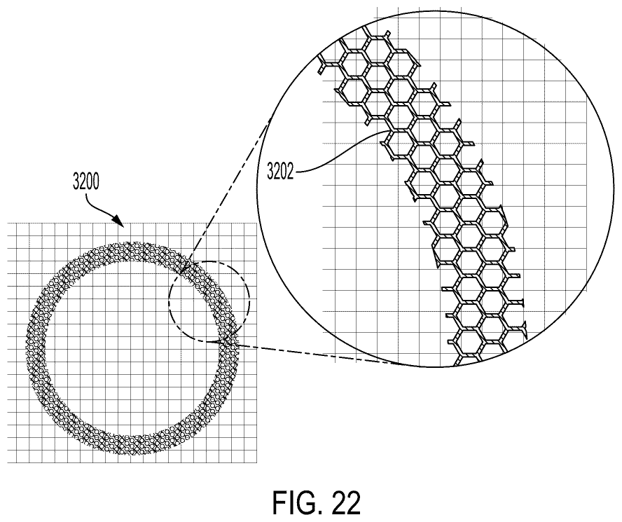

Referring to FIGS. 20-22, example contact surfaces resulting from a sealing blade interfacing with an etched surface are illustrated. In FIG. 20, a sealing blade contacts the valve seat in a contact pattern 3000 that maintains a single continuous path 3002 as a leak barrier. In FIG. 21, a sealing blade contacts the valve seat in a contact pattern 3100 that maintains two continuous paths 3102 as a redundant leak barrier. In FIG. 22, a sealing blade contacts the valve seat in a contact pattern 3200 that maintains three continuous paths 3202 as a redundant leak barrier. Additional redundant continuous paths to the leak barrier may also be considered.

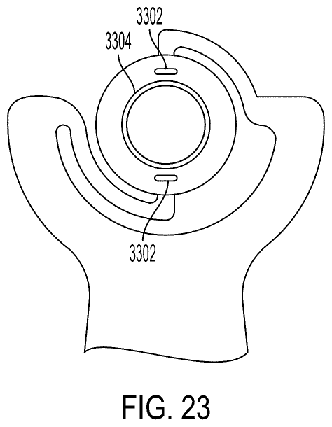

Referring now to FIG. 23, a detailed view of the end of a gimballed cantilevered actuating beam is shown, illustrating a sealing member configuration in accordance with an embodiment. The sealing member (e.g., sealing member 2308) may include a sealing blade 3304 (e.g., sealing blades 2310) and a plurality of flat region features 3302 disposed on the overlapping portion of the actuating beam. The flat region features 3302 may be strategically positioned to provide increased margin against fluid leaking by enhancing the effective “flat region” of the valve interface. This flat region may be a direct function of the lever length between toe and heel contact points, and the inclusion of these features may optimize the sealing performance without compromising other operational characteristics. Although a particular rib configuration is illustrated, this is merely provided as an example. Flat region features 3302 may be included with any embodiment featuring sealing blades 3304 as described herein.

The flat region features 3302 may offer advantages over simply increasing the dimensions of the sealing blade 3304 to achieve similar sealing improvements. While enlarging the sealing blade 3304 to the same outboard dimensions may provide comparable enhancement in the flat region, it could also result in increased surface area and consequently higher stiction forces that could impede the beam's ability to lift off from the closed position. The small flat region features 3302 may effectively separate these two responses, allowing for an increase in the flat region without negatively impacting beam lift-off performance. This configuration may enable the micro-valve to achieve enhanced sealing reliability while maintaining responsive actuation characteristics, potentially improving both the sealing effectiveness and the operational efficiency of the device.

Although some of the non-contact deposition systems referred to herein are described as ink printing applications, this is merely an example. Additional applications are also considered. In the biological and biomedical sectors, these systems may dispense solutions laden with chemicals, biochemicals, or biological molecules onto substrates such as slides, thereby facilitating the creation of microarrays for subsequent analysis. The manufacturing of circuit boards may also benefit from the precision deposition of conductive, semi-conductive, or piezoelectric fluids to form intricate circuits and components. The textile industry may leverage this technology to embed smart textiles with electrical components by applying conductive inks directly onto fabrics.

Surface treatments, such as nanocoatings or anti-microbial layers, may be precisely applied to enhance the functionality of materials (e.g., fabrics or tiles). In the field of 3D printing, these systems may precisely layer polymers to sculpt objects in three dimensions. The food industry may utilize this technology to print informative labels on produce, thereby providing consumers with valuable product insights. Medical research applications may include the deposition of cell stains into cassettes for detailed tissue analysis.

Laboratory research may benefit from the ability to accurately dispense solutions into microwell plates for a variety of assays, including those that measure enzyme activity, conduct polymerase chain reactions, or culture cells. In the cosmetic industry, intricate nail art may be achieved by applying colors or patterns onto nails with precision. Artists and designers may use these systems to mix and apply a spectrum of colors or materials onto palettes or directly onto their chosen canvases, thereby facilitating new avenues for creativity and design. These applications presented herein are merely illustrative and are not intended to be limiting.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A micro-valve comprising:
an orifice plate including a first surface and a second surface, the orifice plate comprising an orifice extending from the first surface to the second surface;
an actuating beam disposed in spaced relation to the orifice plate, the actuating beam comprising:
a base portion separated from the orifice plate by a predetermined distance,
a cantilevered portion extending from the base portion towards the orifice such that an overlapping portion thereof overlaps the orifice, wherein the actuating beam is movable between a closed position and an open position, and
at least one rib flexibly affixing the overlapping portion to a remainder of the cantilevered portion, wherein the overlapping portion is configured to gimbal with respect to the remainder of the cantilevered portion; and
a sealing structure disposed at the overlapping portion, wherein, when the actuating beam is in the closed position, the cantilevered portion is positioned such that the sealing structure seals the orifice so as to close the micro-valve.

2. The micro-valve of claim 1, wherein the actuating beam comprises a layer of a piezoelectric material, wherein the actuating beam is movable between the closed position and the open position in response to an electrical signal being applied to the piezoelectric material.

3. The micro-valve of claim 1, wherein the sealing structure comprises a valve seat surrounding the orifice, wherein the valve seat is affixed to the orifice plate to define a fluid outlet.

4. The micro-valve of claim 3, further comprising a compliance layer covering at least one of an upper surface of the valve seat that faces the sealing structure or a sealing structure surface facing the valve seat.

5. The micro-valve of claim 4, wherein the compliance layer is etched with one or more features configured to reduce the surface area of the compliance layer.

6. The micro-valve of claim 1, wherein the sealing structure comprises a first sealing blade extending a distance from an exposed surface of the sealing structure towards the orifice plate, wherein the first sealing blade surrounds an entire perimeter of the orifice.

7. The micro-valve of claim 6, wherein the sealing structure comprises a plurality of flat region features disposed on the overlapping portion, the flat region features configured to enhance sealing performance by increasing an effective flat region of a valve interface.

8. The micro-valve of claim 1, wherein the sealing structure comprises a first sealing blade extending a distance from an exposed surface of the valve seat towards the sealing structure, wherein the first sealing blade surrounds an entire perimeter of the orifice.

9. The micro-valve of claim 6, wherein the sealing structure further comprises a second sealing blade surrounding the first sealing blade, the second sealing blade having a second outer diameter that is greater than the first outer diameter but less than the second diameter such that an annular gap is formed between the first sealing blade and the second sealing blade.

10. The micro-valve of claim 1, wherein the at least one rib is affixed to the overlapping portion at a single attachment location.

11. The micro-valve of claim 10, wherein the single attachment location is along a central axis of the actuating beam.

12. The micro-valve of claim 1, wherein the at least one rib is affixed to the overlapping portion at two attachment locations.

13. The micro-valve of claim 12, wherein the two attachment locations are symmetrically located along a central axis of the actuating beam.

14. The micro-valve of claim 12, wherein the two attachment locations are asymmetrically located along a central axis of the actuating beam such that the at least one rib generates an asymmetric peeling force when transitioning the actuating beam from the closed position to the open position.

15. The micro-valve of claim 1, wherein gimballing between the overlapping portion and the remainder of the cantilevered portion is produced predominantly through flexure of the at least one rib.

16. The micro-valve of claim 1, wherein gimballing between the overlapping portion and the remainder of the cantilevered portion is produced predominantly through torsion of the at least one rib.

17. The micro-valve of claim 1, wherein the sealing structure is predominantly cylindrical.

18. The micro-valve of claim 1, wherein the actuating beam is predominantly trapezoidal along the length of the actuating beam.

19. A valve assembly comprising:
a valve body comprising an orifice plate including a plurality of orifices extending therethrough;
a plurality of micro-valves, wherein each of the plurality of micro-valves comprises:
an actuating beam disposed in spaced relation to the orifice plate, the actuating beam comprising:
a base portion separated from the orifice plate by a predetermined distance,
a cantilevered portion extending from the base portion towards the orifice such that an overlapping portion thereof overlaps the orifice, wherein the actuating beam is movable between a closed position and an open position, and
at least one rib flexibly affixing the overlapping portion to a remainder of the cantilevered portion, wherein the overlapping portion is configured to gimbal with respect to the remainder of the cantilevered portion, and
a sealing structure disposed at the overlapping portion, wherein, when the actuating beam is in the closed position, the cantilevered portion is positioned such that the sealing structure seals the orifice so as to close the micro-valve; and
a fluid manifold coupled to each of the plurality of micro-valves to define a fluid reservoir for each of the plurality of micro-valves.

20. The valve assembly of claim 19, wherein the at least one rib comprises two ribs affixing the overlapping portion to the remainder of the cantilevered portion at two points.
